(19) United States
(12) Patent Application Publication
(10) Pub. No.: US 2026/0058567 A1
(43) Pub. Date: Feb. 26, 2026

(54) Scalable Indirect Couplers for Current Doubler based Trans-Inductor Voltage Regulator (TLVR)

(71) Applicant: Delta Electronics, Inc., Taipei (TW)

(72) Inventors: Ripun Phukan, Durham, NC (US); Peter Barbosa, Durham, NC (US)

(21) Appl. No.: 18/810,845

(22) Filed: Aug. 21, 2024

(51) Int. Cl. H02M 3/335; H02M 1/00

(52) U.S. Cl. CPC H02M 3/33592; H02M 1/007; H02M 3/33571; H02M 3/33573; H02M 1/0064; H02M 3/33546

(57) ABSTRACT

The present disclosure provides a converter module having at least a first converter and a second converter. In one aspect, the first converter includes first primary side circuitry having first primary side switches, first secondary side circuitry having a first current doubler and first secondary side switches, the first current doubler including a first pair of inductors having first secondary windings integrated in a first core, and a first transformer coupled to the first current doubler. The second converter includes a second primary side circuitry having second primary side switches, second secondary side circuitry having a second current doubler and second secondary side switches, the second current doubler including a second pair of inductors having second secondary windings integrated in a second core, and a second transformer coupled to the second current doubler. The converter module further comprises a tertiary winding loop having an inserted inductor and first and second tertiary windings coupling the first pair of inductors with the second pair of inductors.

### FIELD OF THE INVENTION

The present invention relates to DC power converters, and more particularly, Trans-Inductor Voltage Regulators.

### BACKGROUND OF THE INVENTION

Trans-Inductor Voltage Regulators (TLVRs) represent a fairly recent solution to addressing transient load responses in power applications. In general, TLVRs replace traditional inductors with N:1 ratio transformers (also referred to as trans-inductors). TLVRs assist voltage regulator modules in achieving rapid transient load responses and voltage regulation while reducing the need for large output capacitors. TLVR topologies may be used on conventional current or voltage source-based secondary configurations used in isolated DC-DC converters. They are often a recommended industry solution for scalable DC-DC converters.

Traditionally, current doubler rectifiers are widely used as an isolated secondary stage in LVDC (low-voltage DC) output circuits due at least in part to the low component count and inherent output current ripple filtering offered by the associated output inductors. As such, the output inductors tend to be bulky, which can compromise power density. Consequentially, various magnetic integrated schemes have been developed that use EE cores to realize a negatively coupled output inductor (see, e.g., Peng Xu, Qiaoqiao Wu, Pit-Leong Wong and F. C. Lee, “A novel integrated current doubler rectifier,” APEC 2000. Fifteenth Annual IEEE Applied Power Electronics Conference and Exposition (Cat. No.00CH37058), New Orleans, LA, USA, 2000, pp. 735-740 vol. 2). FIG. 1A shows an example TLVR power module 10 that includes a current doubler rectifier based LVDC stage. The TLVR power module 10 includes primary side circuitry and secondary side circuitry. The primary side circuitry includes a half bridge (HB) circuit 12 comprising switches Q1 and Q2 and capacitors. The secondary side circuitry includes a current doubler 14 and plural switches SR1 and SR2 complementary to switches Q1 and Q2, respectively. A trans-inductor, or as generally termed hereinafter, transformer 16, is represented within the dashed box, and in this example, includes two primary windings and two output inductors. The transformer 16 may be used to step down the voltage from the primary side to the secondary side. Winding references a and b on the primary side inputs and c, d, and e on the secondary side are described with regard to flux path in FIG. 1B below. The output inductors behave as magnetizing inductors, which may be integrated using two stacked EE cores. The scheme shown in FIG. 1A aims to combine the transformer and the output inductor stage within the same EE core. FIG. 1B shows the transformer 16 of FIG. 1A integrated on a single elemental EE core with the corresponding winding references a, b, c, d, and e. Also shown are the limbs or pillars of the EE core, with a dot signifying an outward flux direction (out of the page) in the outer pillars 1 and 2 and an x signifying an inward flux direction (into the page) in the center pillar. Also shown is a flux associated with primary winding defined by a, b, a flux associated with a secondary winding defined in one half of the current doubler 14 and defined by c, d, and a flux associated with a secondary winding of the other half of the current doubler 14 and defined by d, e. As illustrated in FIG. 1B, while the primary winding a, b is constructed such that the flux through the center pillar is cancelled, the two secondary output windings c, d and d, e are constructed to aid in flux addition through the center pillar. This creates an inverse coupling between the two outer secondary windings, which results in control over transient inductance and steady state inductance values, metrics used for dynamic transient performance and steady state ripple. Typically, this results in a reluctance diagram 18 shown in FIG. 1C. L_{m,p} is equal to L_{m,s}, and nₚ is equal to nₛ. Referring to FIG. 1A and FIG. 1C for some of the terms used below, the self-inductance of two output windings (L_{o,1}=L_{o,2}=L_{m,p}) in this case would be half of the total magnetizing inductance.

| | |
|---|---|
| ${L}_{m , p} = \frac{{{n}_{p}}^{2}}{{R}_{g 1}}$ | (1) |
| ${L}_{m , s} = \frac{{{n}_{s}}^{2}}{{R}_{g 1}}$ | (2) |
| ${L}_{o , 1} = {L}_{o , 2} = \frac{{{n}_{s}}^{2}}{{R}_{g 1} + {R}_{g 2}}$ ${L}_{o , 1} = {L}_{o , 2} = \frac{{{n}_{s}}^{2}}{{R}_{g 1}} = {L}_{m , s} ; {R}_{g 1} >> {R}_{g 2}$ | (3) |

FIG. 2A shows another TLVR power module 20, which is a scaled version of the TLVR power module 10 of FIG. 1A. The TLVR power module 20 extends the work for multiple parallel output stages using a matrix transformer concept for a representative two output channel configuration. In effect, the TLVR power module 20 includes two converters 22 (shown on the top) and 24 (shown on the bottom) corresponding in this example to two channels, each with a similar arrangement on the primary and secondary side that is an extension of the TLVR power module components on FIG. 1A. For instance, the converter 22 comprises a half-bridge circuit 26 on the primary side having two switches Q1 and Q2, and on the secondary side, has the current doubler 28, including complementary switches SR1 and SR2. The converter 22 has a transformer (TR₁) 30 comprising two primary windings (1 and 2), and two output inductors denoted by Lₘ₁ and Lₘ₂. Similarly, the converter 24 comprises a half-bridge circuit 32 on the primary side having two switches Q3 and Q4, and on the secondary side, the current doubler 34, including complementary switches SR3 and SR4. The converter 24 has a transformer (TR₂) 36 comprising two primary windings (3 and 4), and two output inductors denoted by Lₘ₃ and Lₘ₄.

FIG. 2B is a scaled version of FIG. 1B and includes the two elemental transformers (TR₁, TR₂) combined into one integrated compact structure (single core structure). In particular, FIG. 2B shows a single EE core that integrates the transformers 30 and 36, with the alphanumeric notations ax, bx, cx, dx, and ex, where x is 1 or 2, representing the winding references associated with the corresponding flux as similarly described above for FIG. 1B. For instance, shown are outer pillars 1, 2, 3, and 4 corresponding to windings 1-4, with an inward flux represented by an x and an outward flux represented by a dot. FIG. 2C shows an equivalent printed circuit board (PCB) implementation 38 and includes the two elemental transformers in a compact structure sharing a common PCB with integrated windings. The PCB implementation 38, like the diagram above it, includes four (4) outer pillars 40 for the windings (1,2,3,4) and central pillars 42 acting as an inverse coupling pass. Note that the other components represented in FIG. 2C are the capacitors and switches. The transformer windings are wound on the outer pillars while the central pillar is utilized for inverse coupling between output windings. Referring to FIG. 2B, while the primary flux cancels in the center pillar, the secondary flux from two output windings adds up to create an inverse coupled inductor at the output. The structure utilizes the magnetizing inductance to create the inverse coupler and behaves as two discrete output inductors coupled through the center pillar. Additional information on multiple parallel output stages may be found in X. Lou and Q. Li, “300A Single stage 48V Voltage Regulator with Multiphase Current Doubler Rectifier and Integrated Transformer,” 2022 IEEE Applied Power Electronics Conference and Exposition (APEC), Houston, TX, USA, 2022, pp. 1004-1010.

A common problem with multi-channel coupling is the presence of asymmetry between channels. FIG. 3A shows a plan view of a PCB implementation 44 of the TLVR power module 20 of FIG. 2A, the PCB implementation 44 similar to that shown in FIG. 2C except with different flux directions, with outer pillars 40 and central pillars 42 and flux directions including an inward flux (represented by an x) corresponding to the outer pillars 40 an outward flux (represented by a dot) corresponding to the central pillars 42. Note that the respective flux directions of the central and outer pillars are for illustrative purposes, with the more relevant feature being that the flux direction of the central pillar is opposite the flux direction of the outer pillar. FIG. 3B shows a side view of an example pillar arrangement 46 of FIG. 3A and the windings. For instance, the windings for the four trans-inductances (e.g., as shown in FIG. 2A) from left to right in FIG. 3B (and from top to bottom) may be as follows: 1 (c-d, a-b, a-b, c-d, c-d, a-b, a-b, c-d), 2 (d-e, a-b, a-b, d-e, d-e, a-b, a-b, d-e), 3 (c-d, a-b, a-b, c-d, c-d, a-b, a-b, c-d), and 4 (d-e, a-b, a-b, d-e, d-e, a-b, a-b, d-e). FIG. 3C shows a corresponding magnetic reluctance diagram 48. Generally speaking, based on the flux coupling, the innermost and outermost pillars are loosely coupled compared to inner pillars, resulting in potential asymmetry in effective inductance values at the output. More specifically, it is noticeable from the resulting magnetic reluctance diagram 48 in FIG. 3C that the coupling between the two outer pillars carrying output current flux is not symmetrical. Particularly, the coupling between output flux of two extreme pillars (corresponding to Iₛ₁ and Iₛ₄) is smaller than the coupling between any two intermediate pillars (corresponding to Iₛ₂ and Iₛ₃). Coupling is denoted by the dashed lines in FIG. 3C. Accordingly, a loss of coupling is expected with an increase in the number of channels.

Since the reluctance path is not symmetrical between adjoining channels, as shown in FIG. 3C, there is a possibility of significant mismatch in root-mean-square (RMS) and peak current distribution between channels. Although one solution may involve active balancing control on each output channel, such a solution may also enforce a higher component count (e.g., with a higher cost and larger footprint).

FIG. 4 shows an example TLVR power module 50 scaled to four channels in parallel at the output. The input (primary side circuit) is configured as a full-bridge rectifier circuit. The combination of a full-bridge rectifier circuit and the additional channels may be used in higher power applications (e.g., compared to the prior TLVR power modules described above). The TLVR power module 50, similar to the previous mentioned TLVR power modules, is scaled with additional elemental transformers 52. However, as described above, the additional channels pose a challenge of asymmetrical reluctance. From a circuit point of view, the TLVR power module 50 is very complicated to design and may be prone to manufacturability issues to maintain a symmetric reluctance network. In general, existent multi-phase couplers may suffer from scalability issues due to manufacturing difficulties seen or expected with higher channel counts.

Reference is made to FIG. 5, which is a composite, schematic diagram 54 showing the prior described PCB implementation 38 (FIG. 2C), a core with windings about the central pillar, and a plot that plots the current distribution in the windings arising from closely spaced windings in compact matrix integrated structures such as those shown in FIGS. 3A, 3B, and 4. Current is concentrated at the edges of the windings, where the edges are close to each other. Hotspots may lead to difficulty in thermal management. In addition to asymmetry issues, there exists the challenge of high frequency winding losses (see, e.g., P. L Dowell, “Effects of eddy currents in transformer windings,” Electrical Engineers, Proceedings of the Institution of, vol. 113, pp. 1387-1394, 1966) due to winding proximity in a matrix transformer configuration. The current density distribution is illustrated in FIG. 5 at the corner point of the two elemental transformers. With the closely-spaced windings often inherent in such structures, a high magnetomotive force (MMF) is created, which may result in higher AC losses while also concentrating the current at the edges (also referred to as current crowding, which is common to integrated PCB plus winding structures assembled in a single core). A compact structure like matrix integrated magnetics may result in higher losses due to proximity and skin effect induced losses as illustrated in FIG. 5. Eventually, these effects often lead to a complicated cooling system design. Furthermore, the manufacturing and mass production difficulties are evident with multi-phase integrated magnetics.

### SUMMARY OF THE INVENTION

In accordance with an aspect of the present disclosure, there is provided a converter module having at least a first converter and a second converter. In one aspect, the first converter includes first primary side circuitry having first primary side switches, first secondary side circuitry having a first current doubler and first secondary side switches, the first current doubler including a first pair of inductors having first secondary windings integrated in a first core, and a first transformer coupled to the first current doubler. The second converter includes a second primary side circuitry having second primary side switches, second secondary side circuitry having a second current doubler and second secondary side switches, the second current doubler including a second pair of inductors having second secondary windings integrated in a second core, and a second transformer coupled to the second current doubler. The converter module further comprises a tertiary winding loop having an inserted inductor and first and second tertiary windings coupling the first pair of inductors with the second pair of inductors.

These and other aspects of the invention will be apparent from and explained with reference to the embodiment(s) described hereinafter.

### BRIEF DESCRIPTION OF THE DRAWINGS

Many aspects of the embodiments of the present invention can be better understood with reference to the following drawings, which are diagrammatic. The components in the drawings are not necessarily to scale, emphasis instead being placed upon clearly illustrating the principles of the embodiments of the present invention. Moreover, in the drawings, like reference numerals designate corresponding parts throughout the several views.

FIG. 1A is a schematic diagram that shows an example TLVR power module with a current doubler based LVDC stage.

FIG. 1B is a schematic diagram that shows an example core showing the flux of the integrated magnetic structures of the TLVR power module of FIG. 1A.

FIG. 1C is a schematic diagram that shows an example reluctance diagram for the TLVR power module of FIG. 1A.

FIG. 2A is a schematic diagram that shows an example TLVR power module scaled with two output channels.

FIG. 2B is a schematic diagram that shows an example core showing the flux of the integrated magnetic structures of the TLVR power module of FIG. 2A.

FIG. 2C is a schematic diagram that shows an equivalent PCB implementation of the TLVR power module shown in FIG. 2A.

FIG. 3A is a schematic diagram that shows an equivalent PCB implementation of the TLVR power module shown in FIG. 2A.

FIG. 3B is a schematic diagram that shows a side view of the pillars with windings for the TLVR power module shown in FIG. 2A.

FIG. 3C is a schematic diagram that shows an example magnetic reluctance diagram pertaining to the winding structure shown in FIG. 3B.

FIG. 4 is a schematic diagram that shows an example TLVR power module scaled to four output channels and with primary side circuitry arranged according to a full-bridge rectifier configuration.

FIG. 5 is a composite, schematic diagram that shows a winding structure, equivalent PCB implementation, and plot of the current distribution arising from closely spaced windings in the compact matrix integrated structure of FIGS. 3A, 3B, and 4.

FIG. 6 is a schematic diagram that shows a generalized embodiment of a TLVR power module that uses discrete magnetics for its indirectly coupled magnetic structure.

FIG. 7A is a schematic diagram that shows an embodiment of a TLVR power module in which the transformer and output inductors are separated for each converter and each output inductor is coupled through a tertiary winding connecting the other tertiary winding in series.

FIG. 7B is a composite, schematic diagram that shows an equivalent integrated magnetic implementation and flux direction of the TLVR power module of FIG. 7A.

FIG. 8A is a schematic diagram that shows another embodiment of a TLVR power module in which two tertiary loops are shown with inherent coupling between inserted inductors between the loops.

FIG. 8B is a composite, schematic diagram that shows an equivalent integrated magnetic implementation and flux direction of the TLVR power module of FIG. 8A.

FIG. 9A is a schematic diagram that shows another embodiment of a TLVR power module in which one transformer is used to construct a single current doubler with two output inductors, primary winding and a coupled winding.

FIG. 9B is a composite, schematic diagram that shows an equivalent integrated magnetic implementation and flux direction of the TLVR power module of FIG. 9A.

FIG. 9C is a composite, schematic diagram that shows yet another equivalent integrated magnetic implementation and flux direction of the TLVR power module of FIG. 9A.

FIG. 10A is a schematic diagram that shows the generalized embodiment of the TLVR power module shown in FIG. 6 along with an embodiment of a control module.

FIG. 10B is a composite, schematic diagram that shows additional control features that may be optionally applied individually or in any combination for the control module of FIG. 10A.

FIG. 11A is a plot diagram showing example simulated results for the TLVR power module of FIG. 8A.

FIG. 11B is a plot diagram with a zoomed-in view of transient performance for the results shown in FIG. 11A.

FIG. 11C is a plot diagram with a zoomed-in view of steady state performance for the results shown in FIG. 11A.

FIG. 12A is a plot diagram showing example simulated results for the TLVR power module of FIG. 9A.

FIG. 12B is a plot diagram with a zoomed-in view of transient performance for the results shown in FIG. 12A.

FIG. 12C is a composite plot diagram with a zoomed-in view of transient performance for the results shown in FIG. 12A for different values of Lc.

FIG. 12D is a plot diagram with a zoomed-in view of steady state performance for the results shown in FIG. 12A.

FIGS. 13A-13B are composite plot diagrams showing various plots demonstrating benefits of using various features of an embodiment of the control method.

FIG. 14 is a schematic diagram that shows the TLVR power module with the magnetic structure of FIG. 9B using a full-bridge rectifier on the primary side.

FIGS. 15A and 15B are schematic diagrams that show alternate input configurations for use with a current doubler configuration, including input parallel and series configurations, respectively.

FIG. 16 is a flow diagram that shows an embodiment of an example control method.

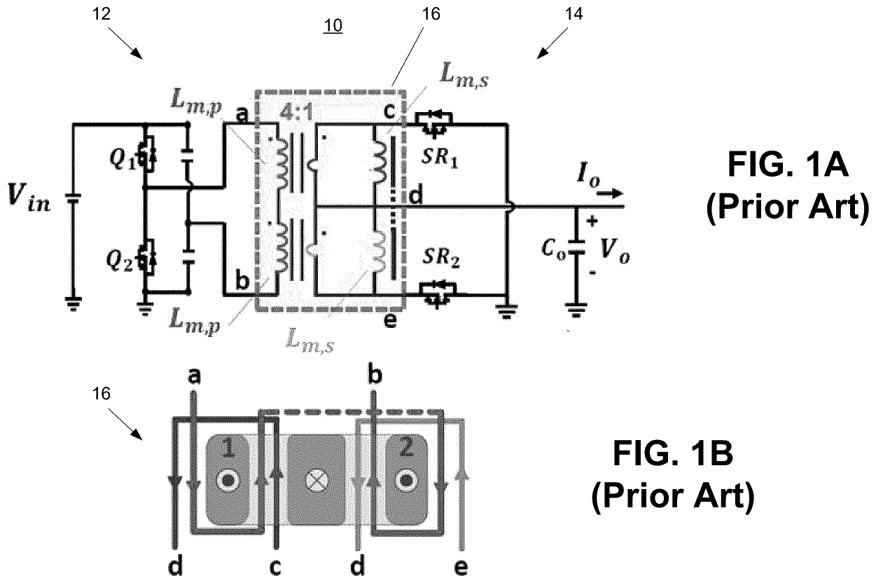

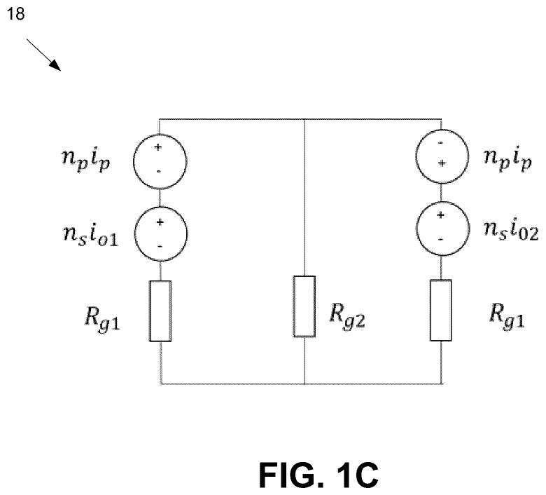

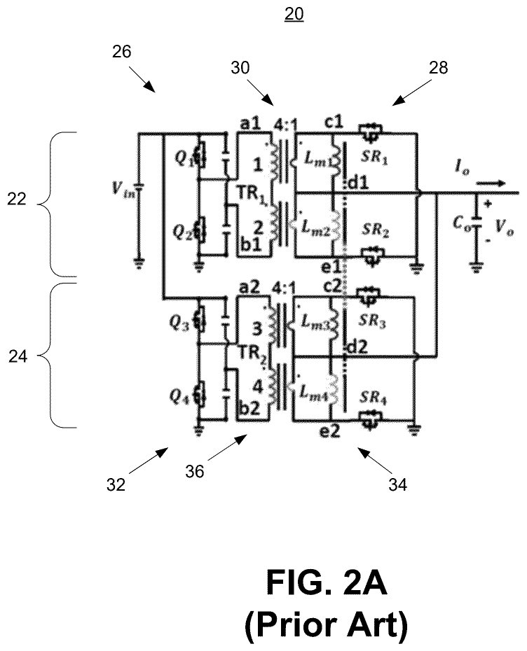

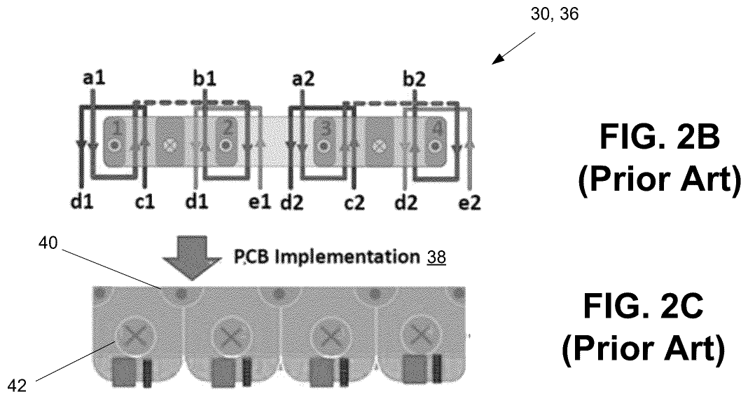

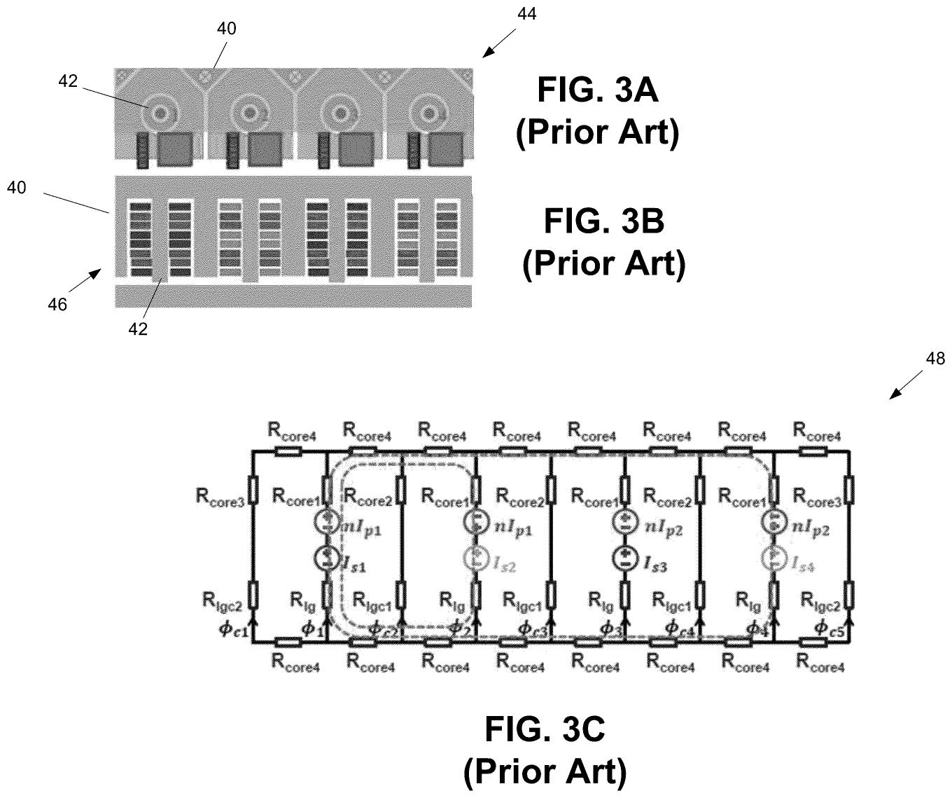

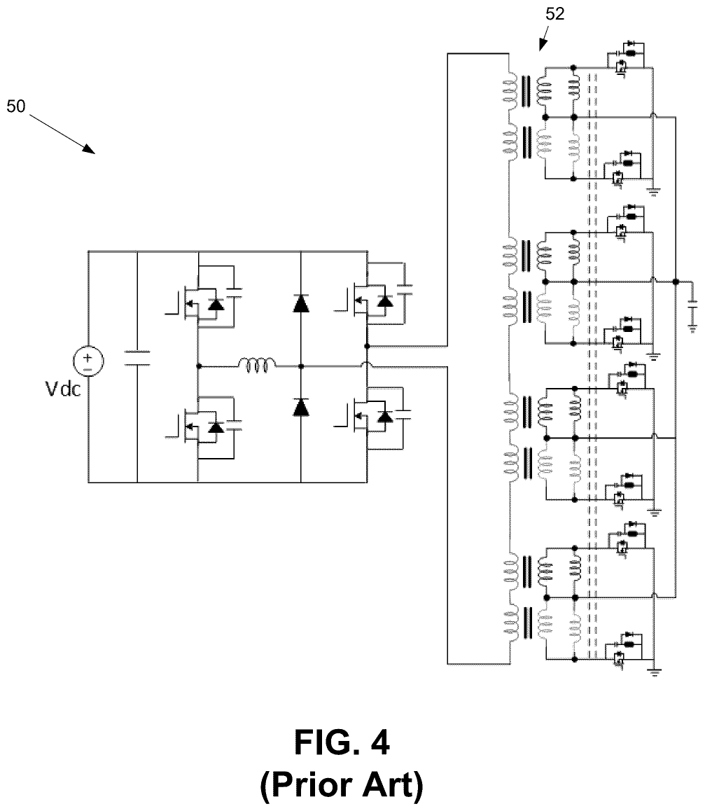

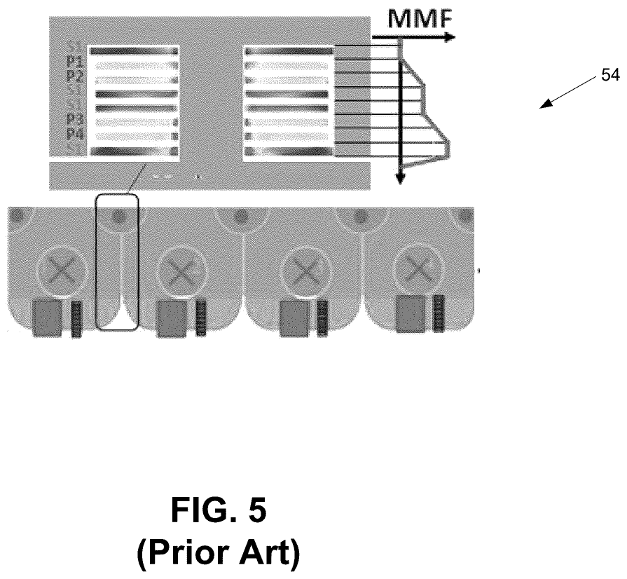

### DETAILED DESCRIPTION OF EMBODIMENTS

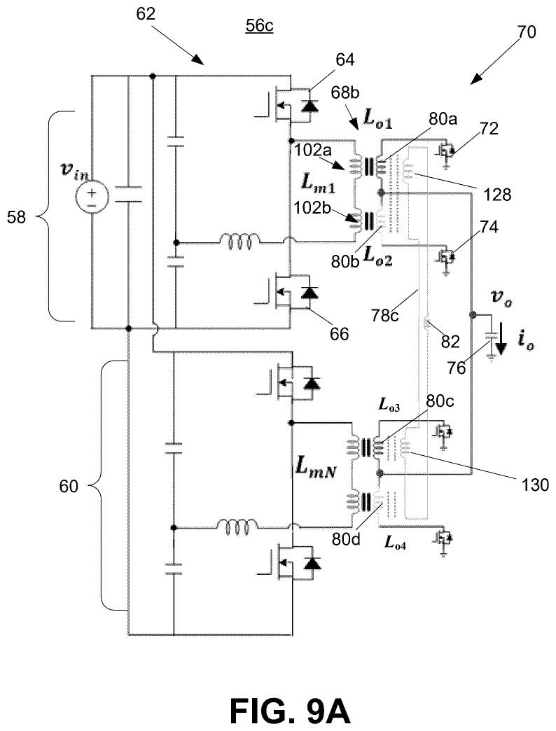

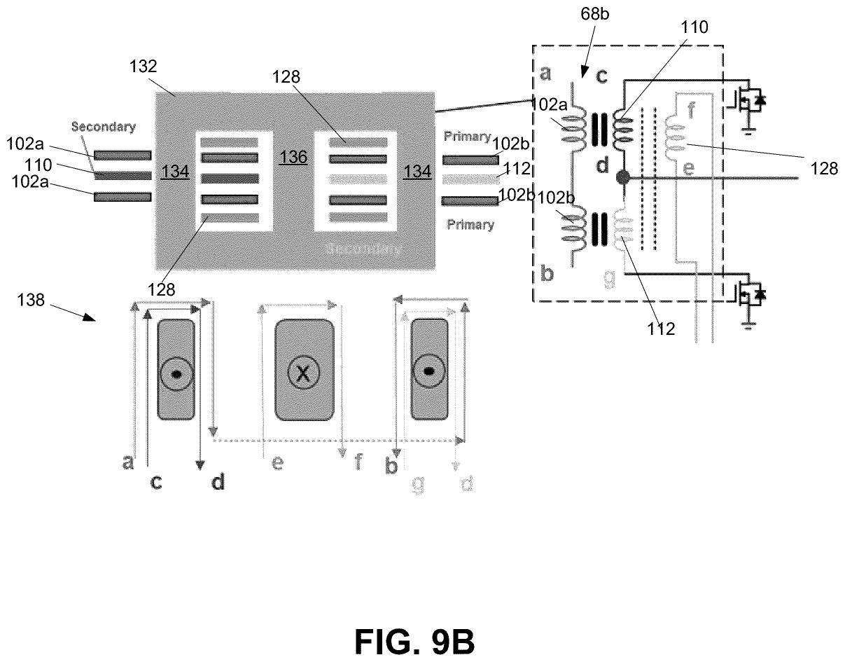

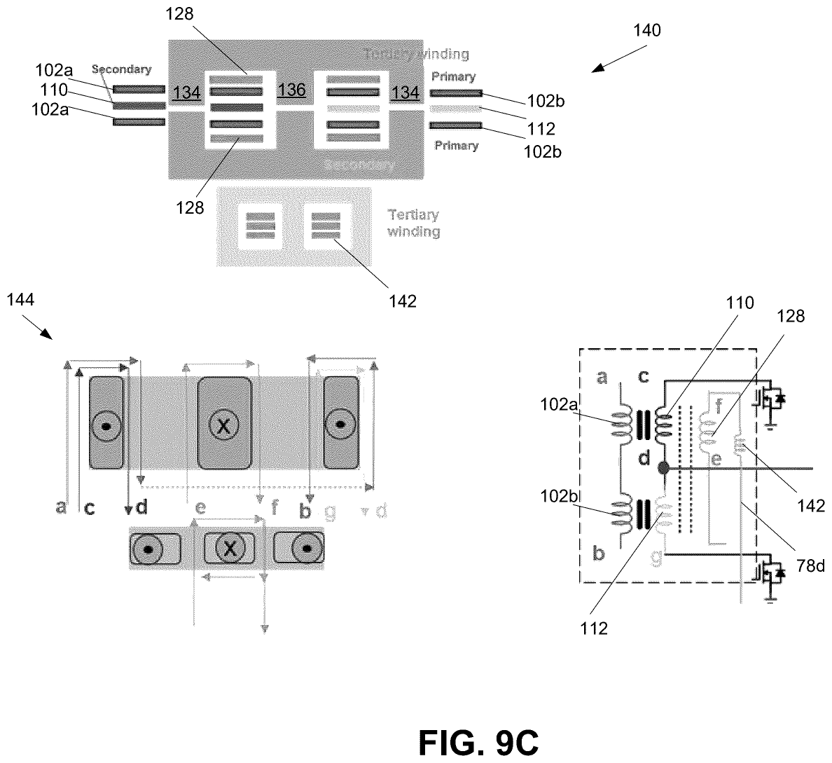

Certain embodiments of TLVR power modules are disclosed, with particular emphasis on a scalable parallel output stage of current doublers that are realized using an arrangement of indirectly coupled inductors with inserted impedance. The indirect coupling is achieved using a coupled winding. By sensing a loop current of the coupled (or also, tertiary) winding(s) and using valley current mode control, fast transient control is enabled, which may result in low voltage undershoot during step load changes. In one embodiment, the TLVR power modules include a discrete arrangement of output inductors, which leads to a self-balancing nature of output currents irrespective of asymmetry between channels. Explaining further, the discrete arrangement may be in the form of a current doubler circuit block that includes an integrated transformer with primary, secondary, and tertiary windings (see, e.g., FIG. 9A, with two converters and a respective current doubler circuit block at the output for each converter, as explained further below). Although each current doubler circuit block has some integration within it, the current doubler circuit block as a whole serves as a discrete building block that enables scaling of TLVR power modules for additional output channels. Additionally, the indirect couplers can be tuned to provide a dedicated output ripple with respect to net loss and volume requirements. The discrete arrangement of inductors (or, more generally, current doubler circuit blocks) also facilitates cooling channel design. The power density of the proposed structures may be enhanced using an EE/EI core implementation.

Additionally, certain embodiments of control methods and associated modules are disclosed which may facilitate the balancing of currents among channels and/or assist in rapid responses to transient loads. In one embodiment, the control methods include current valley control with constant on-time control, and/or in some embodiments, adaptive on-time control. In addition, or alternatively, one or more other control features may be implemented in some embodiments.

In general, certain embodiments of TLVR power modules provide a unique arrangement of indirectly coupled inductors that may be used for multi-output, high power applications to maintain symmetry, meet transient and steady-state ripple requirements, and/or achieve current sharing between output channels. Further, one or more of the TLVR power modules described herein may achieve high manufacturability and scalability by virtue of their compact, discrete implementation. Compared to existing devices/methods, the TLVR power module embodiments described herein use the benefit of inverse coupling and distributed magnetics.

Having summarized certain features of TLVR power modules of the present disclosure, reference will now be made in detail to the description of TLVR power modules as illustrated in the drawings. While TLVR power modules will be described in connection with these drawings, with emphasis on a half-bridge, parallel input configuration, a current doubler output configuration, and two output channels, there is no intent to limit it to the embodiment or embodiments disclosed herein. For instance, implementations that use more than two channels and/or use a full-bridge and/or a series input configuration with possibly fewer channels may also be used and hence are contemplated to be within the scope of the invention. In addition, or alternatively, certain embodiments of TLVR power modules described herein may be extended to multi-level primary converter variants. Also, though a control scheme emphasizing current valley mode control with continuous on-time (and adaptive on-time in some embodiments) is disclosed for a particular control module architecture, it should be appreciated that certain embodiments of TLVR power modules described herein may use other control strategies/architectures, including non-linear controllers or proportional-integral-derivative (PID) controllers. Further, although the description identifies or describes specifics of one or more embodiments, such specifics are not necessarily part of every embodiment, nor are all of any various stated advantages necessarily associated with a single embodiment. On the contrary, the intent is to cover alternatives, modifications and equivalents included within the principles and scope of embodiments of the disclosure as defined by the appended claims. For instance, two or more embodiments may be interchanged or combined in any combination. Further, it should be appreciated in the context of the present disclosure that the claims are not necessarily limited to the particular embodiments set out in the description.

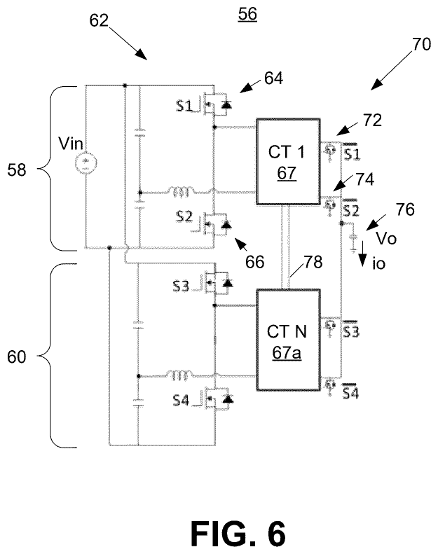

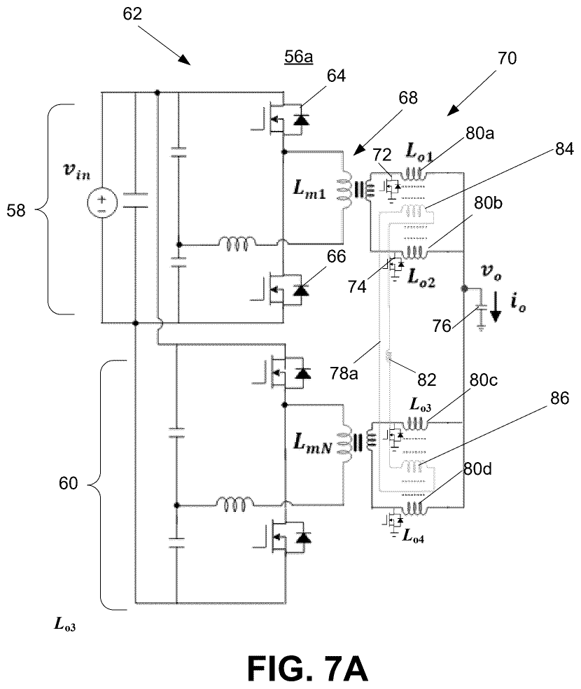

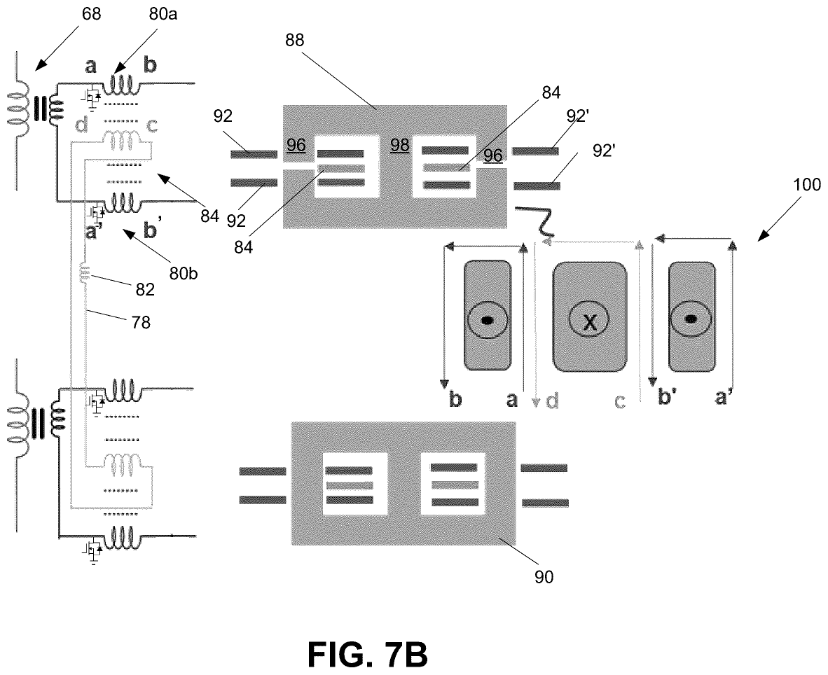

FIGS. 6-9C illustrate scalable indirectly coupled magnetic structures using discrete magnetics, and as indicated above, are described in the context of primary side circuitry configured in a half-bridge configuration, a trans-inductor or transformer, and secondary side circuitry arranged in a current doubler configuration, where the transformers are coupled using tertiary windings of a tertiary winding loop. Referring now to FIG. 6, shown is a generalized embodiment of an example TLVR power module 56. Note that reference to TLVR power module is also referred to hereinafter as a converter module. The TLVR power module 56 shows 1 to N converters 58, 60, which in this example, corresponds to 1 to N parallel channels, where N is an integer number greater than or equal to 2. The TLVR power module 56 receives an input voltage source, Vin, and converts Vin to a different (e.g., lower) voltage at the output, Vo. Referring to converter 58, with similar description applicable to other converters (e.g., converter 60) of the TLVR power module 56, the converter 58 includes primary side circuitry 62. The primary side circuitry 62 includes an arrangement of capacitors, inductance, and switches typical of DC converter circuitry, and in this example, includes a first switch 64 at the positive DC terminal and a second switch 66 at the negative DC terminal. The primary side circuitry 62 is coupled to coupled transformers 67 (coupled transformer (CT) 1 67 in this example). Coupled transformer 1 67 is coupled on the positive side to the primary side circuitry 62 at the output of switch S1 64 and coupled to the primary side circuitry 62 at the negative side via switch S2 and an intervening inductor, where the inductor branches from between a serial arrangement of capacitors as shown in FIG. 6. Coupled to the output of coupled transformer 1 67 is secondary side circuitry 70. Secondary side circuitry 70 includes switches 72 (S1 (not)) and 74 (S2 (not) arranged at the output of coupled transformer 1 67. Switch 72 is complementary to switch 64 (e.g., when switch 64 is on, switch 72 is off), and switch 74 is complementary to switch 66, as is known. A similar description applies to the primary and secondary side circuitry for converter 60 and coupled transformer N 67a, where the description is omitted here for brevity. Also shown is output capacitor 76. Coupling the transformers 67 and 67a is a tertiary winding loop 78. In the illustrated example of FIG. 6, the TLVR power module 56 includes two coupled transformers 67, 67a, where the tertiary windings of the tertiary winding loop 78 achieves inverse coupling. Inductance in the tertiary winding is added to control the output current ripple and ensure good transient performance. This inductance (not shown in FIG. 6), denoted as Lc, is added in series with the tertiary winding loop 78. The TLVR power module 56 is shown with a half-bridge input configuration, though as indicated above, may be configured as a full-bridge circuit in some embodiments. FIGS. 7A-9C extend the generalized embodiment to a two converter, or in these instances, two channel, implementation, where the aforementioned structures referenced in FIG. 6 are also shown with the same reference numbers in FIGS. 7A-9C with similar applicability (and hence discussion of the same is omitted for brevity unless otherwise noted). Suffixes (e.g., a, b, etc.) added to the same reference numbers in FIGS. 7A-9C are used to indicate a difference (e.g., in structure and/or arrangement) among the various embodiments. It should be understood by one having ordinary skill in the art that the description below pertaining to two channels may be extended to a different number of channels, and hence are contemplated to be within the scope of the invention.

FIG. 7A shows an embodiment of a TLVR power module 56a in which the transformer and output inductors, or generally, the current doubler circuit blocks (e.g., including the primary, secondary and tertiary windings for each converter, which collectively is referred to as coupled transformer 1 67 in FIG. 6 for the converter 58), are separated among the converters 58 and 60 and each output inductor is coupled through the tertiary winding as part of a tertiary winding loop connecting the other tertiary windings in series. FIG. 7B shows an equivalent integrated magnetic implementation and flux direction of the TLVR power module 56a of FIG. 7A. Referring to FIG. 7A, shown are similar components as described above for FIG. 6 for a two converter, or in this example, a two channel configuration, including the transformer 68 having a primary winding, along with the addition of output inductors 80 (e.g., denoted Lₒ₁ 80a, Lₒ₂ 80b, Lₒ₃ 80c, and 80d Lₒ₄) having secondary windings and arranged in a current doubler configuration. The output inductors 80 are connected together through the tertiary, or also referred to as coupled, windings of the tertiary loop 78a. It is also noted that the current doubler circuit block of each converter 58, 60 are discrete blocks that are coupled to each other via the tertiary winding loop 78a. An inductance added in the tertiary winding loop 78, namely inductor L_{c} 82, is used to control the steady state and transient inductance. Dynamics of the scheme shown in FIG. 7A are discussed as follows. Note that the output inductors 80 for each converter (e.g., 80a, 80b for converter 58) are coupled to a single tertiary winding 84 (and tertiary winding 86 for converter 60) of the tertiary winding loop 78a. Assume for the sake of reducing mathematical rigor, there is instead a 1:1 correspondence between the tertiary winding of the tertiary winding loop 78a and the corresponding windings of the output inductors (e.g., corresponding windings associated with output inductor 80a and output inductor 80b). By solving Kirchoff's Voltage Law (KVL) in the loops, the current i_{c} in the tertiary winding of the tertiary winding loop 78a can be expressed as (4).

| | |
|---|---|
| $\frac{{di}_{c}}{dt} = \frac{Lm}{Lc + NLm} {\sum }_{j = 1}^{N} \frac{{di}_{o}}{dt}$ | (4) |

Clearly, from (4), average output ripple current flowing through the top or bottom switches 64, 66 (e.g., synchronous rectifier or SR switches) of one channel is seen across the tertiary winding current i_{c}. In other words, the tertiary loop current does not change with number of channels as the number of parallel channels are increased with a higher power requirement. The flexibility to add additional inductance external to the tertiary winding loop 78a (i.e., L_{c}) also enables a designer to control the steady state ripple across the output currents. Increasing L_{c} reduces the steady state ripple and vice versa. This is explained through dynamic equations in the following section(s).

By further solving (4), the voltage drop across each output inductor 80 (e.g., generally, v_{Loj}) can be expressed as (5). From (5), the equivalent self and mutual inductance is derived and shown in (6).

| | |
|---|---|
| ${v}_{Loj} = Lm ( 1 - \frac{Lm}{Lc + N \cdot Lm} ) \frac{{di}_{oj}}{dt} - \frac{{Lm}^{2}}{Lc + N \cdot Lm} {\sum }_{{x = 1}_{x \neq j}}^{N} \frac{{di}_{ox}}{dt}$ | (5) |
| $Leq = Lm ( 1 - \frac{Lm}{Lc + N \cdot Lm} ) ,$ $Meq = \frac{{Lm}^{2}}{Lc + N \cdot Lm}$ | (6) |

Now, depending on duty cycle, the steady state and transient inductance is derived as shown in (7) for 0<D<1/n.

| | |
|---|---|
| $Lss = \frac{( Leq - Meq ) ( Leq + ( n - 1 ) Meq )}{Leq + \{ ( n - 2 ) + \frac{D ( n - 1 )}{{D}^{′}} \} Meq}$ $Ltr = ( Leq - ( n - 1 ) Meq )$ | (7) |

For the case i/n<D< (i+1)/n, the inductances are shown in (8).

| | |
|---|---|
| $Lss = \frac{( Leq - Meq ) ( Leq + ( n - 1 ) Meq )}{Leq + \{ ( n - 2 i - 2 ) + \frac{i ( i + 1 )}{nD} + \frac{nD ( n - 2 i - 1 ) + i ( i + 1 )}{{nD}^{′}} \} Meq}$ $Ltr = ( Leq - ( n - 1 ) Meq )$ | (8) |

Note that Lm is the mutual inductance between tertiary and secondary windings in FIGS. 7A and 7B. L_{c} is the inserted inductance 82 in the tertiary winding loop 78a. From (7, 8), the steady state and transient inductance is seen to increase and decrease respectively with increasing Meq. As indicated above, the equations (4)-(8) assumed a corresponding tertiary winding in tertiary winding loop 78a for each inductor 80, whereas FIG. 7A actually shows a single tertiary winding 84 for tertiary winding loop 78a shared between or coupled to the inductors 80a and 80b (e.g., denoted Lₒ₁ and Lₒ₂, with a similar arrangement for tertiary winding 86 and Lₒ₃ and Lₒ₄).

The two output inductors 80a, 80b (or 80c, 80d) are integrated into one structure (e.g., the current doubler circuit block). The dynamics for loop current are shown in (9). The voltage drop across the output inductor 80, or generally, Loj, is shown in (10).

| | |
|---|---|
| $\frac{{di}_{c}}{dt} = \frac{2 Mc}{Lc + NLmc} {\sum }_{j = 1}^{N} \frac{{di}_{oj}}{dt}$ | (9) |
| ${v}_{Loj} = ( Lm - \frac{2 {Mc}^{2}}{Lc + NLmc} ) \frac{{di}_{oj}}{dt} - ( Mm + \frac{2 {Mc}^{2}}{Lc + NLmc} ) \frac{{di}_{oj + 1}}{dt} - \frac{2 {Mc}^{2}}{Lc + NLmc} {\sum }_{\begin{matrix}x = 1 \\ x \neq j \\ x \neq j + 1\end{matrix}}^{N} \frac{{di}_{ox}}{dt}$ | (10) |

The expressions for Lss and Ltr are cumbersome to derive, and hence omitted to avoid obfuscating relevant features of the TLVR power modules.

Referring now to FIG. 7B, shown on the left is a select portion of converters 58 and 60 from FIG. 7A, and in particular (focusing on the top left portion in FIG. 7B for converter 58, with similar applicability for the bottom left portion in FIG. 7B corresponding to converter 60), the primary winding of the transformer 68, the secondary winding for output inductor 80a (the secondary winding denoted by a, b) and 80b (the secondary winding denoted by a′, b′), and the tertiary winding 84 of the tertiary winding loop 78a (the tertiary winding denoted by c, d). Note that the primary winding of the transformer 68, the secondary windings of the inductors 80a,80b, and the tertiary winding 84 denoted by c, d comprise a coupled transformer (e.g., coupled transformer 1 67, FIG. 6). To the right of these converter portions are cores 88, 90 corresponding respectively to the top and bottom portions of the converters shown to the left in FIG. 7B. In other words, the two current doubler inductors 80a, 80b corresponding to the top converter (e.g., converter 58) are integrated in one core 88, which may be configured as an EE/EI core. Similarly, the two current doubler inductors 80c, 80d corresponding to the bottom converter (e.g., converter 60) are integrated in one core 90, which may be configured as an EE/EI core with a similar winding arrangement as shown for core 88 (and hence the discussion of the same is omitted for brevity). Referring to the core 88, the two secondary windings 92, 92′ are wound on the external pillars 96 of the core 88, providing indirect coupling, while the tertiary winding 84 is wound on the center pillar 98, where the total flux linkage in the center pillar is reflected by the flux diagram 100. Four core sets can be used to construct the coupler. As shown in the flux diagram 100, the direct flux from two output inductors (b,a and b′,a′) is coupled to the center pillar 98 (d,c). An indirect loop is constructed around the center pillar (c,d) connecting, in this example, the 4 EE cores in series.

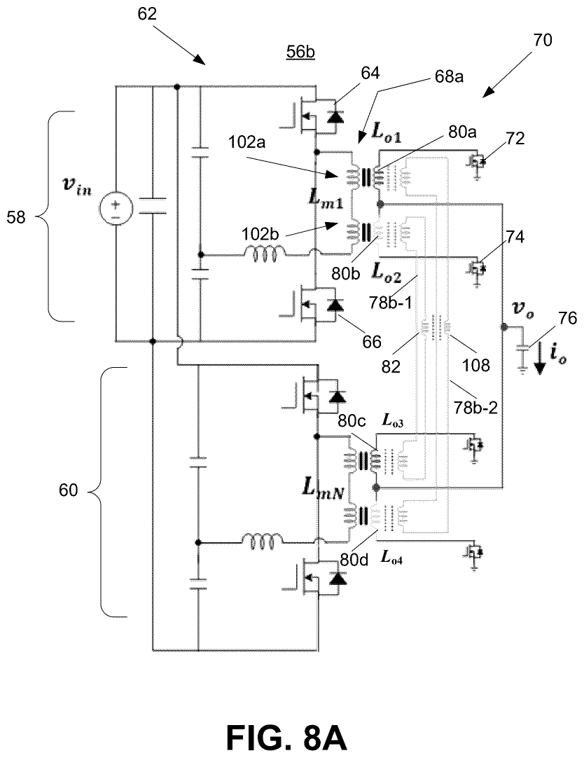

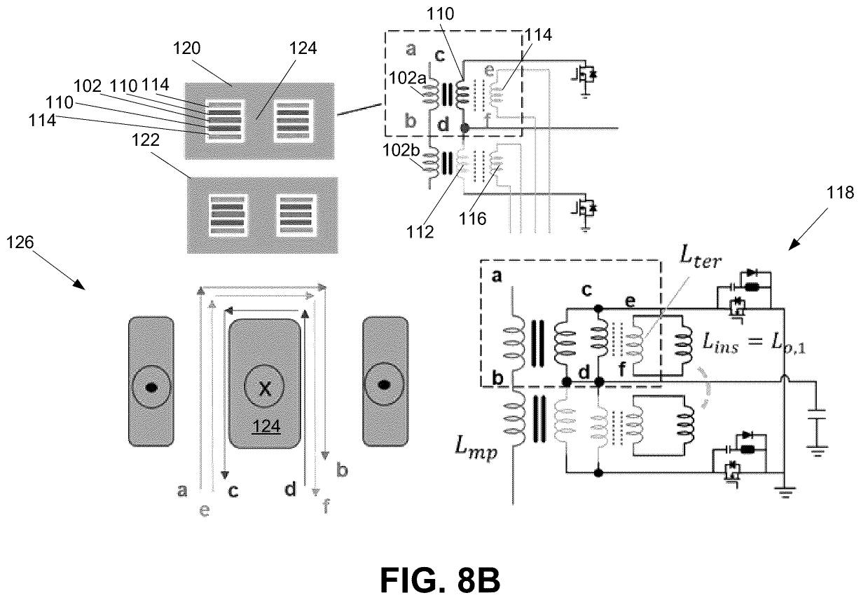

FIG. 8A is a schematic diagram that shows another embodiment of a TLVR power module 56b in which two tertiary winding loops are shown with inherent coupling between inserted inductors between the loops. FIG. 8B is a composite, schematic diagram that shows an equivalent integrated magnetic implementation and flux direction of the TLVR power module of FIG. 8A. Referring to FIG. 8A, shown are similar components as described above for FIG. 7A. Reference numerals that are the same amongst FIGS. 6-10A have a similar description, and hence where the same, are omitted for brevity unless noted otherwise. In this embodiment of FIG. 8A, and again, referring to the top converter 58 (with similar applicability to the bottom converter 60), the transformer 68a (denoted Lₘ₁) is shown with two primary windings 102a, 102b. For instance, primary winding 102a may be wound in a clockwise direction, and primary winding 102b may be wound in a counter-clockwise direction. Note that there is no intent to suggest a certain quantity of turns in FIG. 8A or other figures, which are merely representative schematics shown for purposes of an example illustration. Primary winding 102a is coupled to the secondary winding of output inductor 80a (Lₒ₁), and primary winding 102b is coupled to the secondary winding of output inductor 80b (Lₒ₂). In this case, two tertiary winding loops 78b-1, 78b-2 are used, where the inserted inductances (e.g., inductors 82 and additionally, inductor 108) are positively coupled, which improves power density. In this illustrative example, the tertiary winding loop 78b-1 series connects tertiary windings corresponding or coupled to the output inductor 80b (Lₒ₂) with the tertiary windings corresponding or coupled to output inductor 80c (Lₒ₃), and the tertiary winding loop 78b-2 series connects tertiary windings corresponding or coupled to the output inductor 80a (Lₒ₁) with the tertiary windings corresponding or coupled to output inductor 80d (Lₒ₄). With the coupling of inductors 82, 108 of the different tertiary winding loops 78b-1, 78b-2, an improvement in transient performance may be realized. Notably, the primary windings 102a, 102b, the secondary windings 80a, 80b, and the tertiary windings respectively coupled to the secondary windings 80a, 80b for converter 58 collectively comprise a coupled transformer (e.g., coupled transformer 1 67 (FIG. 6), with a similar grouping of windings associated with the converter 60 corresponding to another coupled transformer (e.g., coupled transformer N 67a).

Before continuing the description for FIG. 8A, an example of operations of the converters (e.g., focusing on converter 58, with similar applicability to converter 60) is described. Note that the description here may be similarly extended to other TLVR power modules described elsewhere herein. In delivering power from the primary side 62 to the secondary side 70, for one switching cycle, current flows from switch 64 (which is on, and switch 66 is off), through primary winding 102a, primary winding 102b, and then returns. On the secondary side, current is transferred from the primary winding 102b to the secondary winding 80b and then to the output (e.g., at output capacitor 76). Since switch 74 is on, the current circulates back to secondary winding 80b. Consequently, energy is delivered from the primary winding 102b, to the secondary winding 80b, and to the output. In the next switching cycle, on the primary side 62, switch 66 turns on (and hence switch 64 is off), and on the secondary side 70, switch 72 conducts (and switch 74 is off), and power is delivered from the primary winding 102a, to secondary winding 80a, and then to the output, Vo, and current recirculates via switch 72 to secondary winding 80a.

FIG. 8B shows on the top right a close-up of the two primary windings 102a, 102b and respective, coupled secondary windings 110, 112 of corresponding output inductor 80a, 80b, and further, the respective, coupled tertiary windings 114, 116 for corresponding tertiary loops 78b-2 and 78b-1. As noted above, the collection of primary windings 102a, 102b, secondary windings 80a, 80b, and tertiary windings 114, 116 comprise a coupled transformer (e.g., coupled transformer 1 67). The bottom right diagram 118 shows an equivalent representation of the top right diagram. For instance, diagram 118 shows a lumped equivalent version of the circuit shown in the top right corner of FIG. 8B, where one difference is the addition of inserted inductors in the loops, Lins. Lins is the inserted inductors (e.g., 82, 108) in the tertiary winding loops. The dashed arc between the top and bottom set of windings in diagram 118 denotes the coupling between the two Lins inductors in the two tertiary winding loops 78b-1 and 78b-2 (FIG. 8A). The top left diagram in FIG. 8B shows that two cores 120, 122 are used for the group of windings for the top converter 58 (FIG. 8A), or more specifically, for the corresponding magnetic structure shown on the top right in FIG. 8B, and similarly, two cores (not shown) are used for the bottom converter 60 (FIG. 8A). Notably, FIG. 8B shows that the primary, secondary and tertiary loop windings are wound on the same core (e.g., referring to core 120 as a representative example) around the center pillar 124. FIG. 8B further shows a flux diagram 126, with the primary flux (a, b), secondary flux (c, d), and tertiary flux (e, f) as shown relative to the center pillar 124.

FIG. 9A shows another embodiment of a TLVR power module 56c in which one transformer is used to construct a single current doubler with two output inductors, primary windings and a coupled winding. FIG. 9B is a composite, schematic diagram that shows an equivalent integrated magnetic implementation and flux direction of the TLVR power module 56c of FIG. 9A. FIG. 9C is a composite, schematic diagram that shows yet another equivalent integrated magnetic implementation and flux direction of the TLVR power module of FIG. 9A. Referring to FIG. 9A, in general, each current doubler output stage is realized using one integrated component to create a highly compact scalable design. Explaining further, similar to FIG. 8A, and focusing on the top converter 58 (with similar applicability to the bottom converter 60 in FIG. 9A), transformer 68b includes primary windings 102a and 102b, which are coupled respectively to the secondary windings (Lₒ₁, Lₒ₂) of output inductors 80a and 80b. Tertiary winding loop 78c includes a single tertiary winding 128 coupled to the secondary windings (Lₒ₁, Lₒ₂) of output inductors 80a, 80b, and similarly, a single tertiary winding 130 coupled to the secondary windings (Lₒ₃, Lₒ₄) of output inductors 80c, 80d. Tertiary winding loop 78c includes inserted inductor 82.

FIG. 9B shows the equivalent integrated magnetic implementation using EE/EI cores. In particular, and referring to the top right of FIG. 9B, shown is a portion from FIG. 9A including the two primary windings 102a, 102b of the transformer 68b, the respective coupled secondary windings 110, 112 of the corresponding output inductors 80a, 80b, and the tertiary winding 128. At the top left of FIG. 9B is a core 132 corresponding to the structure on the top right in FIG. 9B. In this embodiment, the primary 102a, 102b, secondary 110, 112, and tertiary windings 128 (collectively, a coupled transformer, such as coupled transformer 1 67 of FIG. 6) for each converter (e.g., converter 58 in this example) are wound on the same core 132. For instance, primary 102 (e.g., 102a, 102b) and secondary windings (110, 112) are wound around the external pillars 134, while the tertiary winding 128 is wound around the center pillar 136, such that the total output inductor current is coupled to the tertiary winding 128, with natural DC current cancellation in the winding as shown by the flux diagram 138 at the bottom left of FIG. 9B. The primary winding is denoted by a, b, the secondary winding by c, d, and g, d, and the tertiary winding by e, f.

FIG. 9C is a composite diagram that shows yet another equivalent integrated magnetic implementation and flux direction of the TLVR power module of FIG. 9A. Starting at the top of FIG. 9C, shown is a magnetic structure 140 (e.g., for a converter, such as converter 58 of FIG. 9A) for which the primary 102a, 102b, secondary (110, 112), and tertiary windings (128) of the TLVR power module 56c of FIG. 9A may be implemented. In addition, tertiary winding 142 of a distributed loop inductor, Lc, also referred to herein as a baby inductor, may be embedded in the core (wound about central pillar 136) or integrated as an added core (e.g., EE core) component. Below the magnetic structure 140 is a flux diagram 144, which shows the flux for primary (a, b,) secondary (c, d; d, g) and tertiary e, f as similarly described for the flux diagram 138 of FIG. 9B, with the addition of the flux for the tertiary winding 142 for the baby inductor. To the right of the flux diagram 144 in FIG. 9C is the windings portion of a converter, similar to that shown in FIG. 9B, with the addition of the tertiary winding 142 of the baby inductor adjacent the tertiary winding 128 and part of (e.g., series connected to) the tertiary winding loop 78d. In this example embodiment, the collective windings 102a, 102b, 110, 112, and 128, 142 comprise a coupled transformer.

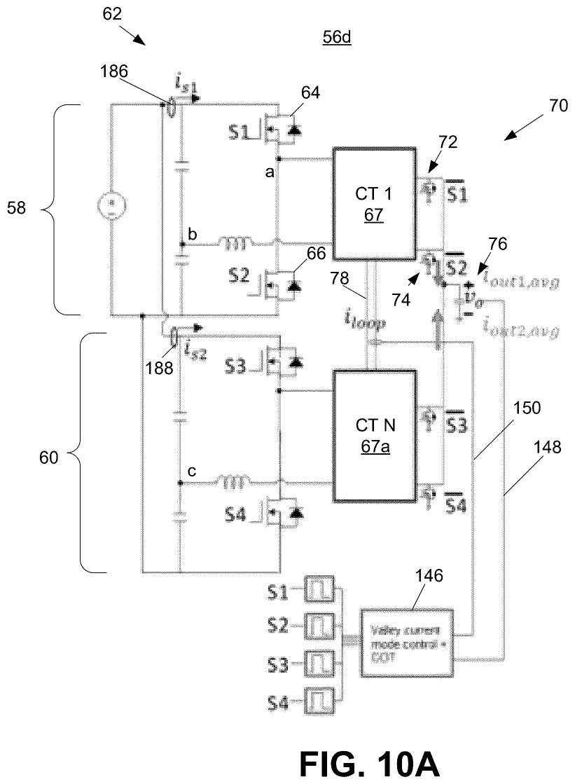

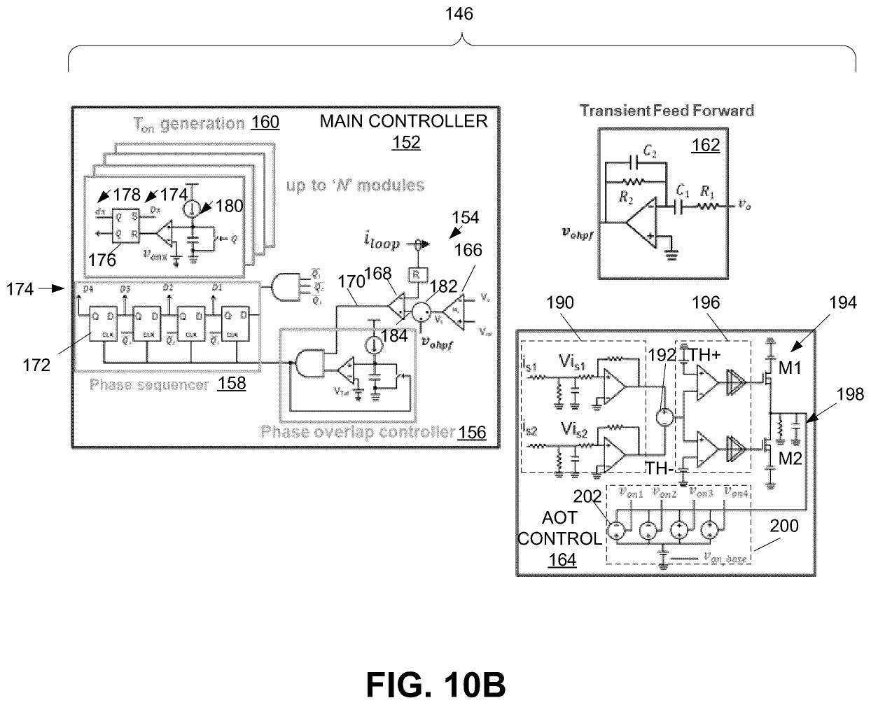

FIG. 10A is a schematic diagram that shows the generalized embodiment of the TLVR power module shown in FIG. 6 along with an embodiment of a control module and some additional annotations. For instance, I_{out,avg} is the average or mean current flowing through each of the current doubler circuit blocks, and includes a DC component and small AC ripple component due to the switching actions within the converter. In effect, the average simply ignores the AC ripple and produces the DC component alone (e.g., the output a low pass filter), while the loop current comprises of predominantly AC ripple component used for output power regulation using COT (constant on-time) control. The I_{out1, avg and} I_{out2, avg} are relied upon for balance control, whereas the loop current is relied upon for output current control. FIG. 10B is a composite, schematic diagram that shows additional control features that may be optionally applied individually or in any combination for the control module of FIG. 10A. Referring to FIG. 10A, one of the additions to FIG. 6 and shown in FIG. 10A is a control module 146. Operation of the TLVR power module 56d is similar to that described for FIG. 8A above, and hence omitted here for brevity. One difference is in the labelling of the switches, where the primary side circuitry 62 includes switches S1, S2, S3, and S4. The secondary side circuitry 70 includes S̅1̅, S̅2̅, S̅3̅, and S̅4̅, where the bar symbol above each switch annotation, S, in FIG. 10A signifies (according to common convention) that the switches on the secondary side circuitry 70 are complementary to the corresponding switches on the primary side circuitry 62 (i.e., S̅1̅ is complementary to S1, S̅2̅ is complementary to S2, and so on). For instance, if S1 is on, S̅1̅ is off at that particular time. In one example operation, S1 turns on, and power is delivered from the source through switch S1. When switch S2 turns on, power flow is similarly from switch S2 and so on, for S3 and S4, with the sequence (S1, S2, S3, and S4) continually repeating itself, with that sequence illustrated by the gate pulse sequence shown at the output of the control module 146. Note that the drawings for the description that follows (e.g., FIGS. 10A-13B) omit S̅ to avoid obfuscating the description of the TLVR power module embodiments, with the understanding that the secondary side switches S̅ (and corresponding gate pulses) are present and complementary to the primary side switches S. When all primary switches are turned OFF, current is freewheeling through the four secondary side switches S̅1̅. . . S̅4̅. In general, an overall function of a TLVR power module, such as TLVR power module 56d, is to convert the input voltage Vin (e.g., 48V input) to an output voltage Vo (e.g., to a 1V output), where the stepping down of voltage (e.g., from a single stage high voltage DC to low voltage DC) is achieved by modulating the switches (e.g., S1, S̅1̅, S2, S̅2̅, etc.) at a particular frequency and according to the transformer turns ratio, where there is a phase shift between the switches S1-S4 as well. Such switching results in certain benefits, such as inverse coupling. To facilitate such functionality, there exists feedback in the form of, for instance, the measured output voltage Vo and the tertiary loop current iₗₒₒₚ. Note that the TLVR power module may be used in step up applications in some embodiments.

Referring now to an explanation of a control scheme of the TLVR power module 56d, the control module 146 may be configured with hardware, software, including firmware, or a combination of hardware and software/firmware. For instance, the control module 146 may be embodied as an analog/digital processor, or as mixed signal integrated circuit. In one embodiment, the control module 146 is configured to implement, at least in part, existing control strategies, including valley current mode control with continuous on-time duration (e.g., of the plural switches S1 64, S2 66, etc.). In one embodiment, the control module 146 is configured to receive the output voltage signal (or simply referred to as the output voltage, Vo) via connection 148 from multiple converters (e.g., converters 58, 60, etc.), receive the tertiary loop current signal (or simply referred to as the tertiary loop current, iₗₒₒₚ) via connection 150 from one or more tertiary winding loops that include tertiary windings, and control plural switches (e.g., S1, S̅1̅, S2, S̅2̅, etc.) of the multiple converters based on the output voltage signal and the tertiary current loop signal. The above-mentioned embodiment enables the use of one lossless current sensor in the tertiary winding loop for control, thereby reducing cost. In effect, the control module 146 uses the tertiary loop current for sensing the ripple component.

FIG. 10B shows additional control features that may be optionally applied individually or in any combination for the control module 146 of FIG. 10A. In particular, the control module 146 includes a main controller circuit or block 152, which in one embodiment includes trigger circuit or sub-block 154, phase overlap controller or sub-block 156, phase sequencer circuit or sub-block 158, and Ton generation circuit or sub-block 160. The control module 146 also includes optional transient feed forward circuit or block 162 and optional adaptive on-time (AOT) control circuit or block 164. In one embodiment, the control module 146 includes the main controller block 152 and optionally one or more of the transient feedforward block 162 and the AOT control block 164.

Input to one or more of these blocks 152, 162, and 164 includes select parameters, including output voltage Vo and tertiary loop current iₗₒₒₚ, sourced from converter outputs of a TLVR power module. The description below emphasizes the TLVR power module 56d (FIG. 10A) as the source of the output voltage Vo and tertiary loop current iₗₒₒₚ, though it should be appreciated that any of the TLVR power module embodiments described herein may source these parameters. For instance, and referring back to FIG. 10A, output voltage Vo (e.g., output voltage signal) is input to the control module 146 via connection 148, and tertiary loop current iₗₒₒₚ (signal) is input to the control module 146 via connection 150. In this particular example, there are four outputs from the control module 146 based on those inputs, namely, the four outputs of gate pulses to the respective primary side switches S1-S4 (and of course, the outputs of gate pulses to the complementary secondary side switches (S̅1̅-S̅4̅, not shown).

Referring again to FIG. 10B, Vo is shown as an input to main controller block 152 and transient feed forward block 162. Also, the loop current is also shown as an input to main controller block 152. More specifically, and referring to the trigger sub-block 154, a compensator (Hv) 166 is shown. The compensator 166 may function similarly to a proportional-integral (PI) controller. The compensator 166 receives as input the output voltage, Vo, and another voltage signal, Vref, which may be a user-inputted or programmed value corresponding to the desired output voltage, Vo (e.g., as compared to the actual output voltage, Vo that the TLVR power module 56d is outputting). Ideally, the output voltage Vo is equal to Vref (i.e., that the TLVR power module 56d is performing according to user demand), and the main controller block 152 is used to achieve such performance via closed-loop control. Transient feed forward block 162 and/or AOT control block 164 may be optionally added to improve performance under certain conditions (e.g., transient load performance, converter imbalance, etc.). In one example operation, based on the inputs of Vo and Vref, the compensator 166 outputs a compensator voltage, Vc. Ignoring Vohpf shown in FIG. 10B for the time being (as it comes from transient feed forward block 162, which is optional), compensator voltage Vc is input to comparator 168. Another input to comparator 168 is a voltage drop derived from iₗₒₒₚ and a programmed value (Ri). In effect, iₗₒₒₚ (multiplied by factor Ri) is compared to Vc at comparator 168. When the compensator voltage, Vc, is higher than the voltage drop (iₗₒₒₚx Ri), a voltage at output 170 (output from comparator 168) is latched to, say, a digital one (1). In other words, the output voltage of comparator 168 is high when the compensator voltage Vc exceeds the voltage drop. Ignoring the phase overlap controller sub-block 156 for now (which also is optional), when the output voltage at output 170 is high, it is input to phase sequencer sub-block 158. In other words, for every trigger (a transition from low to high from the trigger sub-block 154), which is an indication that the output voltage 170 of the comparator 168 is high, one of the logic circuits or gates 172 (e.g., D flip flops) of the phase sequencer sub-block 158 is enabled. As the term phase sequencer implies, based on a first trigger, a first logic gate (e.g., D1) is enabled. For a second trigger, a second logic gate (e.g., D2) is enabled, and for subsequent triggers, D3 and then D4, and then the sequence returns to enabling D1 and so on in sequence (e.g., a circular pattern or sequence).

Continuing the description of an example operation of the main controller block 152, when one of the logic gates 172 (e.g., D1, D2, D3, D4, or more generally Dx) is enabled, Dx output 174 (D1 output, D2 output, etc.) becomes an input to Ton logic gate 176 (e.g., SR logic gate). When Dx output 174 is high, the output 178 (e.g., dx) of Ton logic gate 176 is high, and remains high for a certain or defined (e.g., programmed) on-time duration, Ton. In one embodiment, the on-time is constant. Stated otherwise, for every trigger (e.g., trigger event), the Dx output 174 is high, resulting in the Ton logic gate output 178 to be latched for a certain on-time duration, Ton. When the duration of Ton has elapsed, the output 178 of Ton logic gate 176 transitions to low (e.g., zero). The Ton time (which in one embodiment, is fixed or constant) may be programmed via circuitry 180, which includes a reference voltage (Vonx), capacitor and current source. Notably, the control strategy of valley current mode control with constant on-time (COT) in the context of the present disclosure refers to the fact that every time the tertiary current Iₗₒₒₚ hits a valley point (e.g., a value close to Vc), the output 170 is latched, which triggers the above-described operations or events (e.g., enabling components of the phase sequencer sub-block 158 and Ton generation sub-block 160).

As indicated above, some features shown in FIG. 10B are optional. Attention is now directed to an implementation using these optional features. The phase overlap controller sub-block 156 is a feature added to enhance the transient performance of the TLVR power module 56d, and depends at least in part on the slope of transient current and compensator gain settings. The phase overlap controller sub-block 156 is enabled when there is a step change in the load, such as a step down or a step up. During that instant, the phase overlap controller sub-block 156 creates an overlap sequence of the output pulses for switches S1-S4. Digressing briefly, and referring again to FIG. 10A, in an ideal operating case where there is no transient load, the gate pulses for all of switches S1-S4 are phase shifted. For instance, when switch S1 is on, all the other switches S2-S4 are off. When switch S2 is on, all of the other switches S1 and S3-S4 are off, and so on. Accordingly, for this ideal operating case, at any given instant of time, only one of the four switches S1-S4 is on. Further, the phase shift depends on the load. For instance, for light loads, the phase shift is slightly higher (e.g., because the need for current is much smaller), to the point where under some load conditions, all switches may be off (where the phase shift is much larger and there is no power flow). In other words, there is no need for continual operation of all of the switches S1-S4 for some light loads. Alternatively, under conditions of rated load, the phase shift is smaller. Still, at any given instant, only one of the switches S1-S4 are operating.

With continued reference to FIG. 10A and drawing attention again to FIG. 10B and the phase overlap controller sub-block 156, when there is a transient step, the phase overlap controller sub-block 156 tries to overlap the gate pulses of switches (e.g., turning switches S1 and S3 on at the same time, or turning switches S2 and S4 on at the same time). Explaining further, during a transient load, the output capacitor 76 (FIG. 10A) is impacted more immediately than other components given its proximity to the load compared to the more slowly reacting components upstream of the load (e.g., on the primary side circuitry 62). As a result, the output capacitor 76 influences current flow to the output, with a consequential drop in voltage across the output capacitor 76 according to a certain specification or limit. Voltage drops at or below that limit may be undesirable for performance according to design and/or application specifications. In an effort to avoid or mitigate this risk, because the output capacitor 76 tries to source the transient current as mentioned above, the phase overlap controller sub-block 156 assists the output capacitor 76 in this sourcing role by enabling at least a majority of the switches at the same time to enable more current flow to the output capacitor 76. Notably, there are multiple current flow paths to achieve this function, such as via switches S1 and S3 trying to force or influence more current to the output capacitor 76 during this transient load. Thus, the phase overlap controller sub-block 156 overlaps the gating sequence of, say, switches S1 and S3, and switches S2 and S4. It should be understood by one having ordinary skill in the art that, to avoid shorting the supply, there is to be no overlap of switches of the same converter, such as no overlap permitted between gate pulses of switches S1 and S2, or switches S3 and S4. In other words, the phase overlap is achieved via enabling (e.g., turning on at the same time or in overlapping manner) switches from different converters (converters 56 and 60). Further, other combinations of switches are permissible as long as the enabled switches for phase overlap are from different converters (e.g., instead of enabling switches S1 and S3, enabling switches S1 and S4).

Another optional feature is the transient feed forward block 162. The transient feed forward block 162 also helps with the transient performance by way of a feed forward voltage, Vohpf, which in one embodiment is added to the compensator voltage, Vc. The transient feed forward block 162 includes an op amp circuit in the form of a high pass filter (or band pass filter in some embodiments), which is suggested in the output label, Vohpf. As explained above, when there is a transient load (e.g., step load), the voltage of the output capacitor 76 (FIG. 10A) either increases or decreases at a rapid rate depending on load step up or down respectively. During a transient load, the high pass filter function of the transient feed forward block 162 only passes the AC component, feed forwarding the voltage output, Vohpf. On the other hand, it stands to reason that during steady state operation, the output voltage, Vohpf of the transient feed forward block 162 equals zero, since there is only a DC component at the output (no high frequency component to pass). Accordingly, the transient feed forward block 162 is designed to operate during transient loads, not steady state loads, and facilitates the phase overlap sequence of switching pulses by saturating a compensator or adder output 184 to a level significantly above the feedback voltage drop (other input to the comparator 168) using Vohpf in a feed-forward operation.

At the trigger sub-block 154 of the main controller block 152, the output voltage, Vohpf, and the compensator voltage, Vc, are input to an adder 182, where the adder 182 adds Vohpf and Vc, resulting in an adder output 184. The output 170 of the comparator 168, based on a comparison at comparator 168 between the inputted voltage drop (iₗₒₒₚx Ri) and the adder output 184, achieves a high value at a much faster rate. Explaining further, the comparator 168 compares the voltage drop (from iₗₒₒₚ x Ri), at one input to the comparator 168, to the adder output 184 inputted to the other input of the comparator 168. When the voltage of adder output 184 is higher than the voltage drop, this result gives rise to a positive edge voltage at the output 170, which in turn triggers the rest of the circuitry of the main controller block 152 downstream of the comparator 168 (e.g., phase sequencer sub-block 158 and Ton generation sub-block 160).

Before describing the adaptive on-time (AOT) control block 164, some background on current sharing or balancing of currents is first described below with reference to FIG. 10A as an illustrative example. As described above, the TLVR power module 56d includes two converters 58 and 60. A mismatch between converters in general may result from a difference in manufacturing tolerances, propagation delays in the switch gating sequence, and/or small stray inductances in the layout. By design, it is expected that approximately half of the input current flows through the converter 58, with the other half through the converter 60. However, if the mismatch results in asymmetry, it is possible that one of the converter 58 or converter 60 may carry more current than the other converter, which may result in, for instance, thermal issues (e.g., temperature distribution) that may eventually affect reliability. Balancing between the currents that flow through the two converters 58, 60 may mitigate or remove the effects of these mismatches.

With continued reference to FIG. 10A, and referring also to FIG. 10B, the adaptive on-time (AOT) control block 164 actively changes the on-time (duration) of the pulses of the switches S1-S4, as opposed to the on-time being fixed or constant as explained above for some embodiments. The on-time of the pulses is changed depending on the currents i_{S1} and i_{S2}. The current i_{S1} is sensed at the DC positive terminal 186 as shown in FIG. 10A. The current i_{S2} is sensed at the DC positive terminal 188 as shown in FIG. 10B. In effect, the AOT control block 164 measures the DC currents in channel 1 (the converter 56) and channel 2 (converter 60). Notably, the currents i_{S1} and i_{S2} may also have some high frequency component (e.g., noise), but the currents are predominantly DC. As shown in FIG. 10B, the currents i_{S1} and i_{S2} are passed through signal conditioning circuit 190. The signal conditioning circuit 190 includes a divider network that converts the DC current into equivalent respective voltages Vi_{S1} and Vi_{S2}, which are scaled to values (e.g., 3.3V, 5V, etc.) suitable for processing by a digital controller. From the signal conditioning circuit 190, the scaled down voltages Vi_{S1} and Vi_{S2} are inputted to a subtractor 192. The subtractor 192 outputs a difference between Vi_{S1} and Vi_{S2}, and the output is input to an AOT trigger circuit 194.

The AOT trigger circuit 194 includes a hysteresis amplifier 196. More specifically, the difference, output by the subtractor 192, is one input to the hysteresis amplifier 196. Another input to the hysteresis amplifier 194 includes two threshold levels, a positive threshold level (TH+) and a negative threshold level (TH−), as shown in FIG. 10B. For instance, TH+ may be (+) 5V, and TH− may be (−) 5V. As long as the difference (output) from subtractor 192 is within +/−TH (e.g., +/−5V), the two transistors M1 and M2 of the AOT trigger circuit 194 are off, meaning the AOT control block 164 does not operate (e.g., is not enabled). The moment the voltage difference (output of subtractor 192) exceeds, say, the positive threshold (e.g., +5V), or exceeds the negative threshold value (−5V), then either of these transistors M1 or M2 (e.g., MOSFETS, though not limited to these types) will turn on (depending on which threshold, TH+ or TH− is exceeded). Depending on the transistor that turns on, a capacitor 198 is either charged or discharged. The resulting capacitor value is inputted to an on-time adjust block 200.

The on-time adjust block 200 includes different sub-blocks 202 that are used to adjust (add to or reduce) a base on-time voltage, V_{on,base}. In other words, there is a base on-time voltage (V_{on,base}), which corresponds to a constant on-time (preprogrammed or user configured). Added or subtracted to the base on-time voltage is the voltage of the capacitor 198. The output of the sub-blocks 202 corresponds to different on-times (e.g., Vₒₙ₁₋₄ for the 4 switches S1-S4 in this example). In effect, the AOT control block 164 changes the on-time by measuring the difference in currents i_{S1} and i_{S2}, which is then fed to the hysteresis amplifiers 196 of the AOT trigger circuit 194, which either charges or discharges the capacitor 198. The voltage of the charged or discharged capacitor 198 is then either subtracted or added to the base on-time, which is used to generate the individual adaptive on-times given by the sub-blocks (adders) 202 (e.g., Vₒₙ₁, Vₒₙ₂, etc.). Note that the on-time is actually a unit of time, where Vₒₙ is a voltage. However, as explained above in association with the Ton generation sub-block 160, on-time is generated using Vonx (where x is the switch S1, S2, S3, or S4). Accordingly, though the on-time is a unit of time, it depends on a voltage level Vonx.

A simple illustration of the converter balancing mechanisms described above follows using FIG. 10A. Again, when operating according to a fixed on-time, and with any imbalance in the system, the voltage at node a (and node b) are relevant in the determination of how much current flows to the output capacitor 76. As is understood by one having ordinary skill in the art, DC converters operate using a fixed DC source. However, to control the current through the converter, the DC fixed source should act as a variable DC source, which is achieved by switching Vin on and off via switching (using converter 58, for instance) switches S1 and S2 on and off. Through the switching operation of switches S1 and S2, the average voltage changes as a result. For instance, if Vin is 48V, and the switches S1 and S2 operate according to a 50% duty cycle, then the voltage at node a becomes 24V. The power flow may thus be controlled by controlling the voltage difference between the input (Vin) and the output (Vo), the voltage difference defining how much current goes through the coupled transformer 1 67. Now, consider a mismatch between converters 58 and 60 arising from, say, a difference in impedance of the corresponding coupled transformers (e.g., coupled transformer 1 67 and coupled transformer N 67a). If coupled transformer N 67a has a higher impedance than coupled transformer 1 67, then more current flows through the converter 58 than converter 60 since the impedance of the coupled transformer 1 67 of converter 58 is lower. However, the on-time is fixed (e.g., at 50%). So the voltage at node a (for converter 58) is still 24V and the voltage at node c (for converter 60) is 24V, even though the impedance of coupled transformer 1 67 is lower, resulting in more current flow via node a than via node c. Ideally, the impedances of coupled transformers 67 and 67a are the same, but in practice, there is typically a mismatch (e.g., via tolerance differences, or in general, mismatch between the converters).

Continuing with the present illustration, with a difference in impedance, the current sharing is not uniform. With the implementation of adaptive on-time, according to certain embodiments, the AOT control block 164 may effect change at node a from 50% duty cycle to, say, 25% duty cycle. Stated otherwise, if the coupled transformer 1 67 has a lower impedance than coupled transformer N 67a, then the AOT control block 164 may cause node a to have a slightly lower voltage because the impedance is lower, ensuring that the same or substantially the same current amount flows through all of the coupled transformers of the different converters. Recalling Ohm's law of V=IR, when the impedance of one channel drops, the AOT control block 164 ensures that the voltage of that channel drops to enable the current to remain the same. Changing the on-time adaptively effectively means changing the duty cycle, and thus average voltage, seen at node a (or c, etc.). The adaptive on-time change amounts to a closed-loop, feedback control mechanism that is based on measuring the channel currents (e.g., i_{S1}, i_{S2}, etc.). So, based on the current information (i_{S1} and i_{S2}), the AOT control block 164 decides which channel needs a higher duty cycle and/or which channel needs a lower duty cycle.

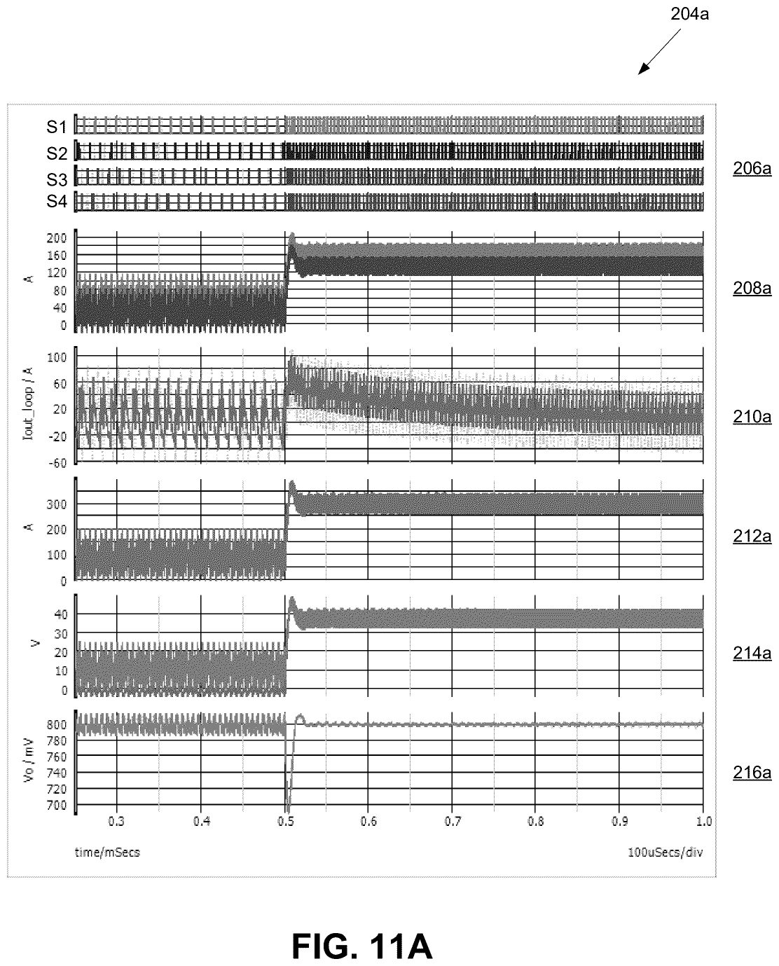

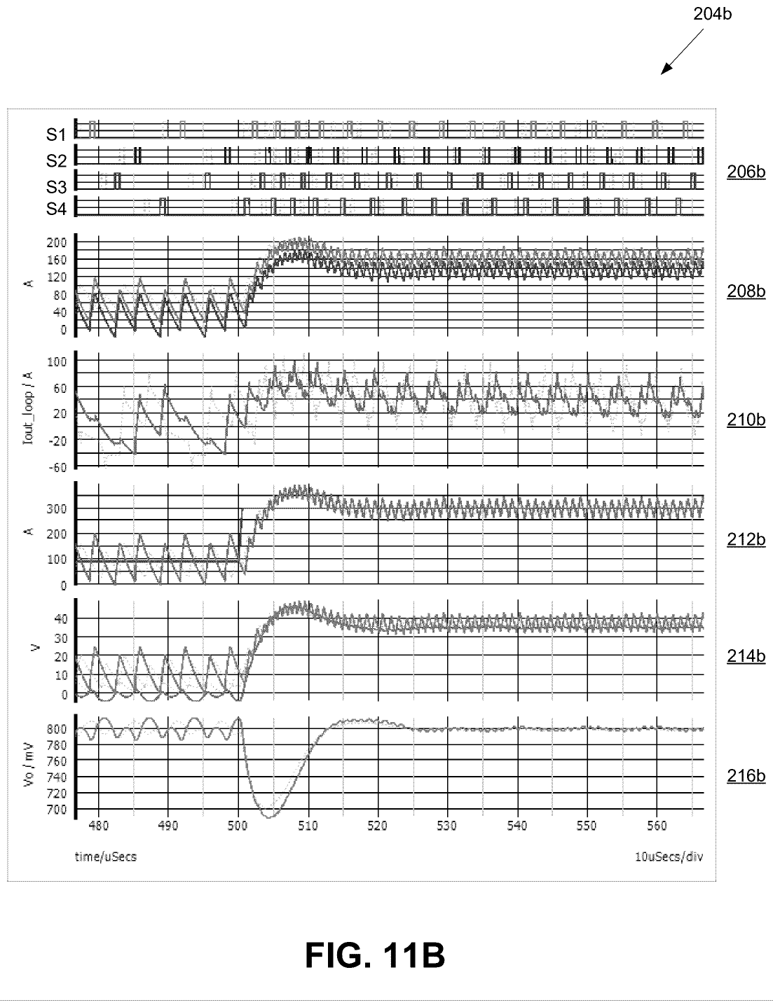

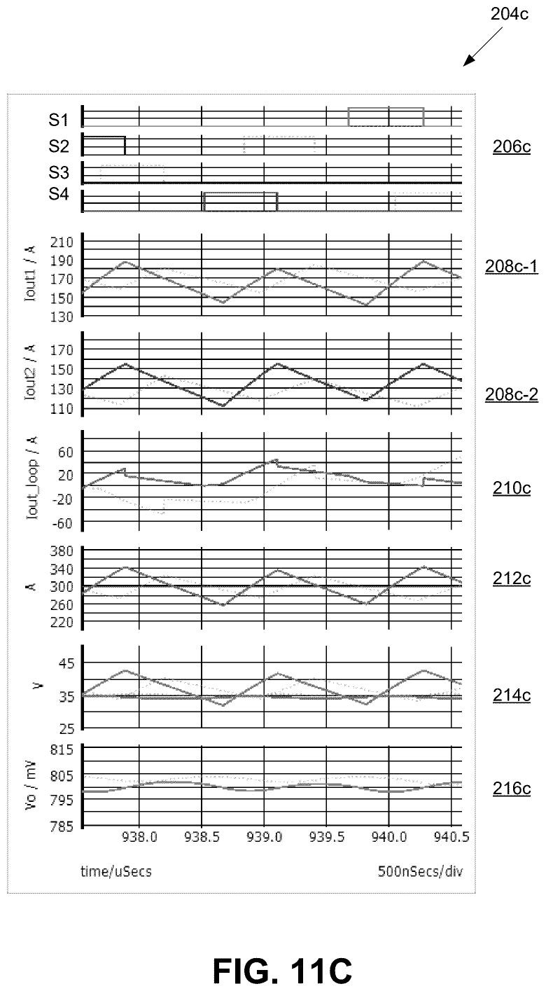

Having described certain embodiments of a TLVR power module and methods of control, attention is directed to FIGS. 11A-13B, which show various simulation results of some of the TLVR power module embodiments described herein. FIG. 11A is a plot diagram 204a showing example simulated results for the TLVR power module of FIG. 8A. FIG. 11B is a plot diagram 204b with a zoomed-in view of transient performance for the results shown in FIG. 11A. FIG. 11C is a plot diagram 204c with a zoomed-in view of steady state performance for the results shown in FIG. 11A. Referring to FIGS. 11A-11C, the plot diagrams 204 (including plot diagrams 204a-204k among FIGS. 11A-13B) share simulations for several types of waveforms. The plot diagram 204a (with similar description for plot diagrams 204b, 204c, etc., using a different suffix, b or c, than that shown for FIG. 11A (suffix a)) includes simulations for gate pulses 206a (e.g., corresponding to switches S1, S2, S3, and S4), converter output current 208a, tertiary loop current 210a, total output (load) current (total channels) 212a, voltage 214a, and output voltage 216a. Time (along each horizontal axis) is measured in milliseconds. Note that the voltage 214 (e.g., a, b, c, etc.) corresponds to the internal operation of the control module 146, and in particular, the trigger sub-block 154 of the main controller block 152. For instance, the trigger sub-block 154 comprises the comparator 168, with the voltage drop (iₗₒₒₚx Ri) as one input and the compensated voltage as the other input to the comparator 168. Referring to voltage 214 in the diagrams (e.g., FIG. 11A), the top or noisy portion is the voltage drop, and the bottom or less noisy portion (e.g., between 0 and 0.5 msec) is the compensated voltage.

In FIG. 11A, it is observed that the transient response takes effect at approximately 0.5 msecs. Of particular relevance to the plot 204a is that phase overlap control is evident as a reaction to the transient response, as shown by the overlapped gate pulses observed in simulated gate pulses 206a. Also, it is noted from simulated tertiary loop current 210a and total current 212a that the tertiary loop current i_{c} has the same AC ripple component as the AC ripple component of the total load current. From the simulated output voltage 216a, it is observed that output regulation is maintained.

Referring to the plot 204b in FIG. 11B, plot 204b is the zoomed in transient performance using the indirect coupler of the TLVR power module 56b of FIG. 8A, and more specifically, and referring to the simulated output voltage 216b, the positive coupling between the two inserted loop inductors ‘L_{c}’ (82, 108 in FIG. 8A), in the two loops 78b-1, 78b-2 (FIG. 8A) leads to lower undershoot. The lower undershoot means a faster transient response and lower steady state ripple (see, e.g., FIG. 11C).

The plot 204c in FIG. 11C shows a zoomed in view of steady state performance using the indirect coupler of the TLVR power module 56b of FIG. 8A. As indicated above, a positive coupling between the two inserted loop inductors ‘L_{c}’ (82, 108 in FIG. 8A) in the two loops 78b-1, 78b-2 (FIG. 8A) leads to lower steady state ripple. It is also noted that simulated converter currents 208c-1 and 208c-2 are shown for both converters 58 and 60 in FIG. 11C.

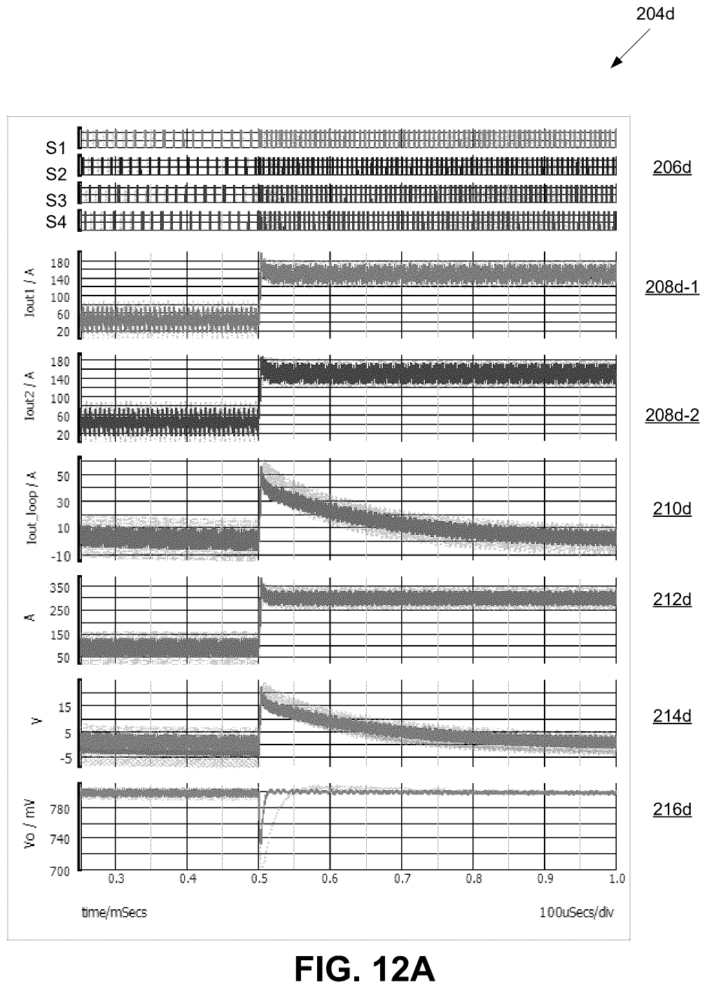

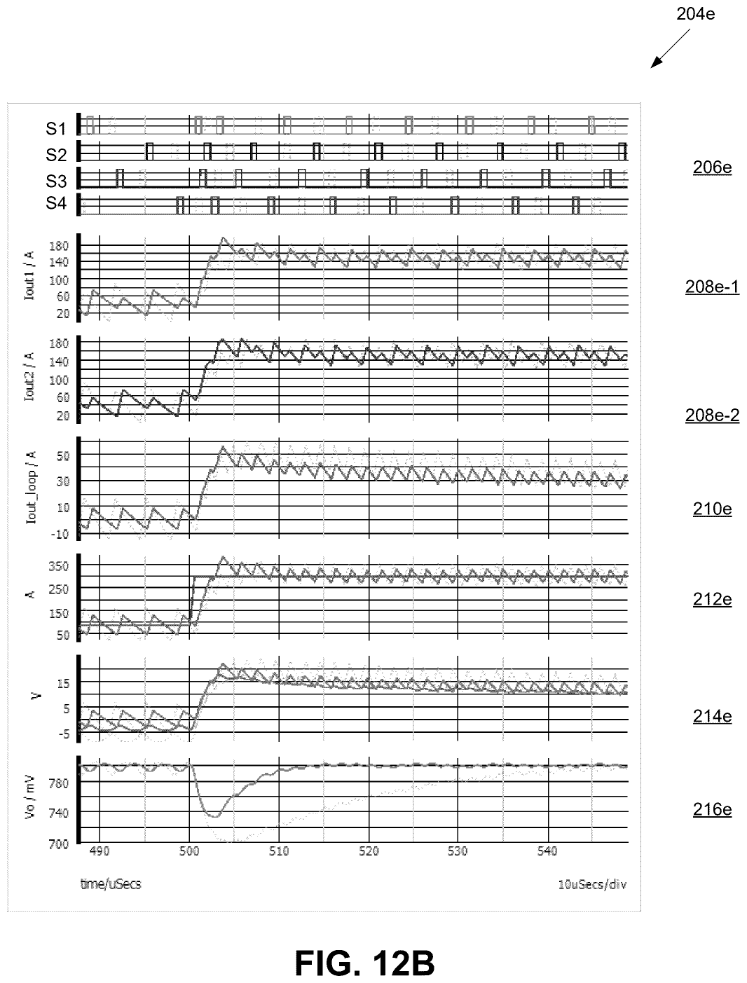

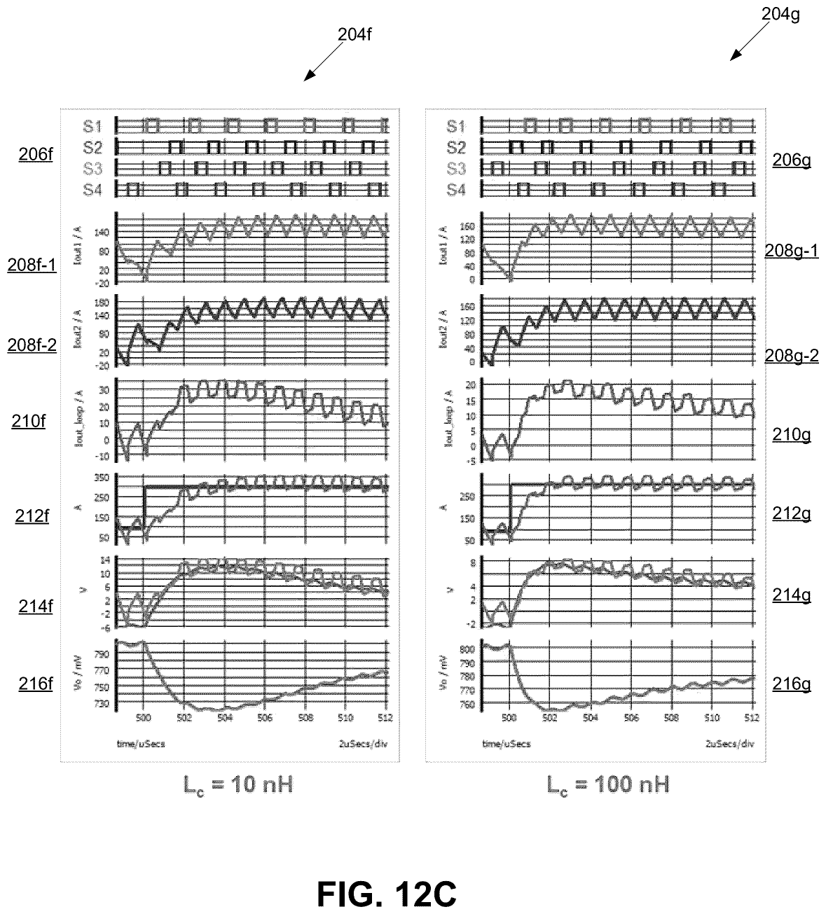

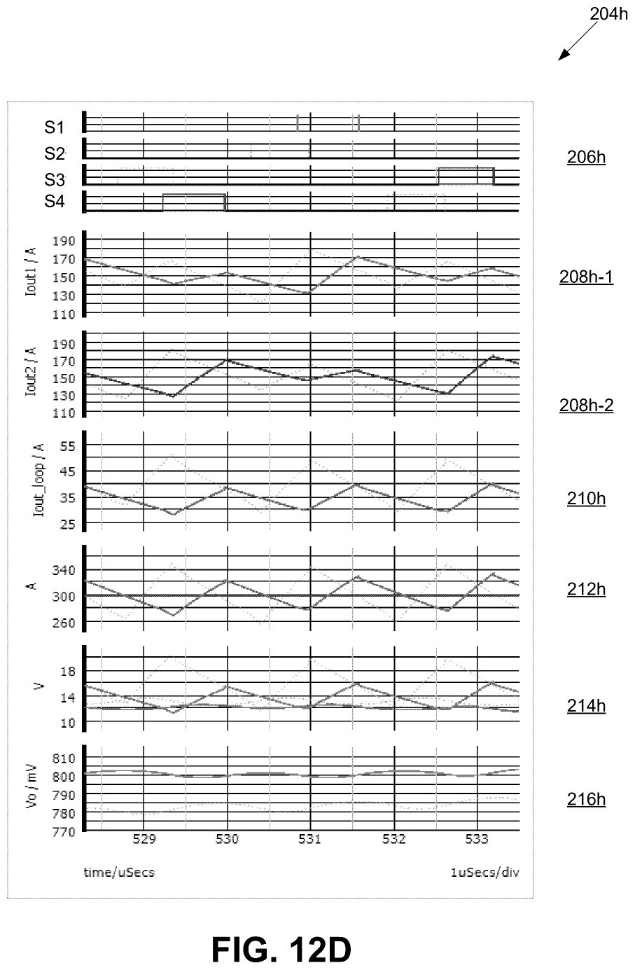

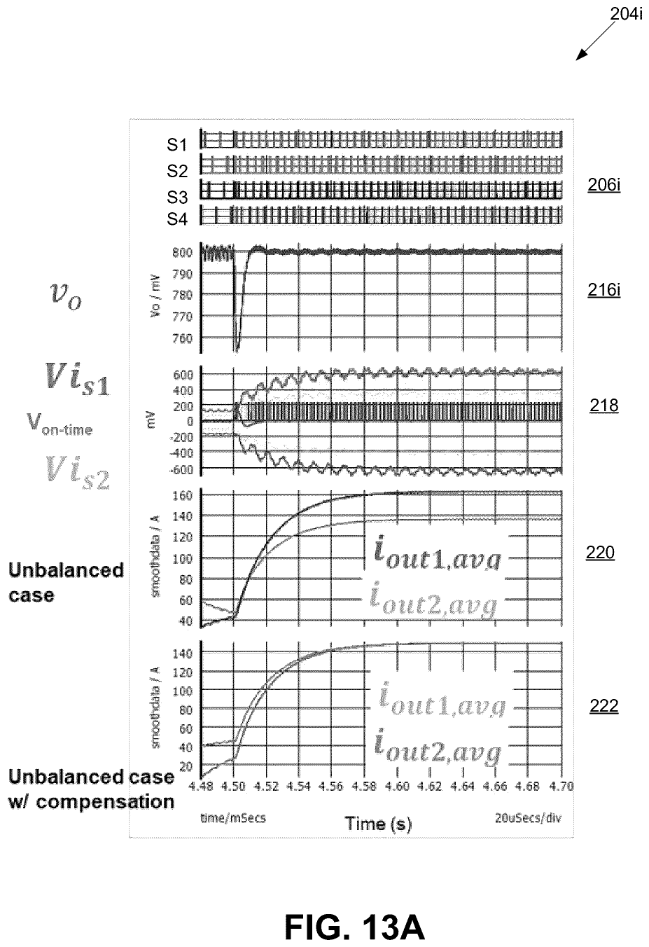

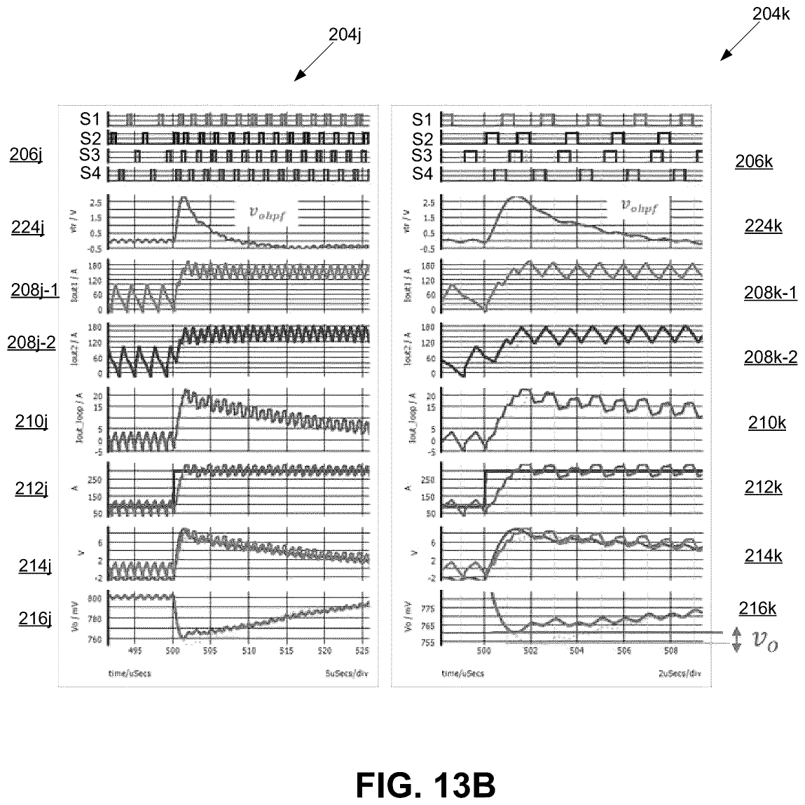

FIG. 12A is a plot diagram 204d showing example simulated results for the TLVR power module 56c of FIG. 9A. FIG. 12B is a plot diagram 204e with a zoomed-in view of transient performance for the results shown in FIG. 12A. FIG. 12C are plot diagrams 204f and 204g with a zoomed-in view of transient performance for the results shown in FIG. 12A for different values of Lc. FIG. 12D is a plot diagram 204h with a zoomed-in view of steady state performance for the results shown in FIG. 12A. It is noted that the reference numerals used in FIGS. 11A-11C are also used for FIGS. 12A-12D (and to some extent, FIGS. 13A-13B), with differences in plots and simulations denoted by the use of different suffixes (and hence discussion of the same is omitted here for brevity, unless noted otherwise below). It is observed from the simulated tertiary loop current 210d and total current 212d in the plot diagram 204d of FIG. 12A that the tertiary winding current i_{c} is equal to the AC ripple component of total output current for the TLVR power module 56c in FIG. 9A. The plot diagram 204e of FIG. 12B shows a zoomed in view of transient performance with the indirect coupler. A high L_{c} leads to lower undershoot due, for instance, to phase overlap being enabled. A comparison of zoomed in responses during a transient load, with different values of L_{c} is illustrated in the plot diagrams 204f and 204_{g} of FIG. 12C. A high value of L_{c} leads to lower undershoot, meaning faster transient response, due also in part to the phase overlap control that is initiated due to a lower slope of sensed current, which also leads to lower steady state ripple as shown in FIG. 12D. In other words, the plot diagram 204h of FIG. 12D shows zoomed in steady state performance with the indirect coupler. A high L_{c} leads to lower steady state ripple.

Note that the example simulation results are in accordance with the analysis presented above in association with equations 7, 8, 9, and 10.

FIG. 13A is a plot diagram 204i showing simulated waveforms illustrating the effect of the adaptive on-time (AOT) control block 164 (FIG. 10B) on the steady state current sharing between the two channels of the TLVR power module 56c in FIG. 9A. 206i shows the primary side gating signals. 216i shows the output voltage transient performance. 218 includes top and bottom waveforms that comprise the scaled down voltages of the measured DC input currents Viₛ₁ and Viₛ₂ (see, e.g., FIG. 10B), respectively. The prominent middle waveform is the hysteresis comparator output, constantly charging and discharging the output capacitor 198 in FIG. 10B to Vₒₙ=0.2 V in this case. This eventually generates Vₒₙₓ (x=1,2,3,4) as the adaptive on voltage, which is translated into adaptive on times for the primary and secondary side switches. 220 is the waveform of output currents without balancing. 222 is the waveform of output currents with balancing according to the AOT control block 164. The iout1,avg and iout2,avg comprise average output currents for channels 1 and 2, respectively. The impact of the AOT control block 164 is shown. For instance, an imbalance in the circuit of FIG. 10A may be introduced in the form of PWM signals for channel 1 compared to channel 2, which results in an imbalance in the channels. One mechanism to solve this imbalance is achieved via implementation of the AOT control block 164 (unbalanced case with compensation).

FIG. 13B includes plot diagrams 204j and 204k, which shows the impact of feed-forward Vohpf (FIG. 10B) added as a feed on transient performance. A slight benefit in terms of a lower undershoot can be seen. 224j shows the post processed HPF output (Vohpf) of the feedback voltage which is used for feed-forward control. 208j-1/2 show the simulated output currents. 210j is the tertiary loop current. 212j is the step command and response. 214j shows the comparator input. 216j shows the voltage output response. By adding the feed-forward component to adder 182 (FIG. 10B), it is observed from 214k that the compensator output V_{c} goes higher than the feedback component (voltage drop iₗₒₒₚ×Rᵢ). This causes the phase overlap controller sub-block 156 (FIG. 10B) to get activated, which leads to better transient performance as seen from the lower undershoot voltage Vₒ.

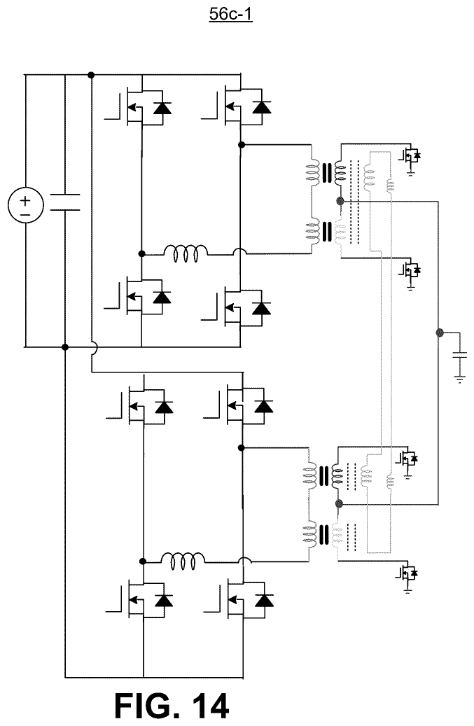

Though the example embodiments above use a half-bridge input type, it should be understood by one having ordinary skill in the art that the TLVR power module embodiments described herein may instead use a full-bridge input type (e.g., for higher power applications, such as at or above approximately 1.5 kilowatts). For instance, FIG. 14 illustratively shows the TLVR power module 56c of FIG. 9A, modified with the magnetic structure 140 (baby inductor, FIG. 9C), and is denoted in FIG. 14 as TLVR power module 56c-1, and further modified using a full-bridge rectifier on the primary side.

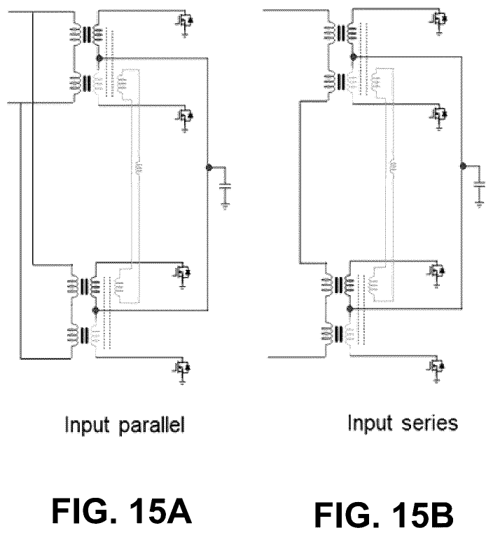

FIGS. 15A and 15B are schematic diagrams that show alternate input configurations for use with a current doubler configuration (e.g., as similarly shown in FIG. 9A), including an input parallel configuration (FIG. 15A) and an input series configuration (FIG. 15B), respectively. Note that FIG. 15B shows a single channel (e.g., two inputs, the top and bottom). Note that the input configurations of half-bridge and full-bridge may be used for any one of the TLVR power module embodiments described herein, along with either a series or parallel input configuration.

It is also noted that certain embodiments of TLVR power modules may be applied with both PCB windings and discrete windings based non-integrated magnetics.

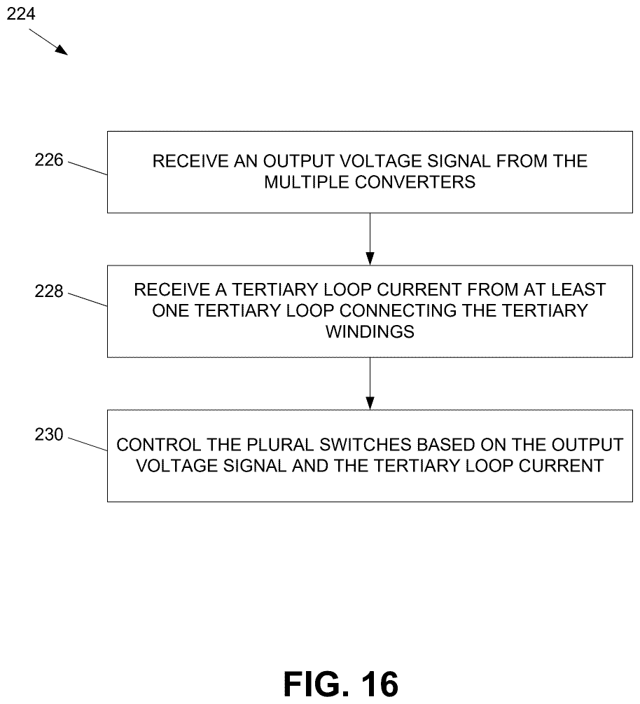

In view of the above-described embodiments, it should be appreciated within the context of the present disclosure that disclosed herein is an embodiment of a control method for controlling a converter module (e.g., any of the TLVR power, or generally, converter, modules 56 (e.g., including 56a, 56b, etc.) described herein), the method denoted method 224 in FIG. 16. The control method 224 may be implemented by a control module (e.g., control module 146, FIG. 10A) for use with any of the converter modules described herein. In one embodiment, the module (e.g., 56a) comprises multiple converters (58, 60) with outputs respectively arranged in a current doubler configuration, wherein the multiple converters comprise plural switches and multiple coupled transformers (67, 67a) comprising primary, secondary, and tertiary windings. In one embodiment, the method comprises receiving an output voltage signal from the multiple converters (226); receiving a tertiary loop current from at least one tertiary loop connecting the tertiary windings (228); and controlling the plural switches based on the output voltage signal and the tertiary loop current (230).

Certain embodiments of TLVR power modules and associated control methods are disclosed that relate to development of modular magnetic coupler architectures for scalable high power TLVR modules. The TLVR power module embodiments are shown according to several arrangements of coupled and discrete inductors that may be used on a conventional current source-based secondary configuration of isolated DC-DC converters. In the examples described above, the TLVR power modules include an architecture that is suitable with current doubler configurations and can achieve lower losses, better manufacturability, scalability, and symmetry with higher output channels. In addition, the indirect couplers may be used to tune the steady state and transient inductance to meet specific requirements for dynamic LV side load requirements.

Having described certain embodiments of a converter module and associated control methods, and with reference to at least FIGS. 7A-7B, it should be appreciated that one example first embodiment of a converter module (56a) includes a first converter (58), including: first primary side circuitry (62) having first primary side switches; first secondary side circuitry (70) having a first current doubler and first secondary side switches, the first current doubler including a first pair of inductors (80a, 80b) having first secondary windings (92, 92′) integrated in a first core (88); and a first transformer (68) coupled to the first current doubler; a second converter (60), including: a second primary side circuitry having second primary side switches; second secondary side circuitry having a second current doubler and second secondary side switches, the second current doubler including a second pair of inductors (80c, 80d) having second secondary windings integrated in a second core (90); and a second transformer coupled to the second current doubler; and a tertiary winding loop (78a) including an inserted inductor (82) and first and second tertiary windings (84, 86) coupling the first pair of inductors with the second pair of inductors respectively.

The example first embodiment may include any one or a combination of the following features.

For the converter module of the example first embodiment, the first and second primary side circuitry comprise a full bridge circuit.

For the converter module of the example first embodiment, the first and second primary side circuitry comprise a half bridge circuit.

For the converter module of the example first embodiment, the first pair of inductors is associated with a first channel and the second pair of inductors is associated with a second channel.

For the converter module of the example first embodiment, the tertiary winding loop connects the first and second tertiary windings and the inserted inductor in a series arrangement.

For the converter module of the example first embodiment, the first secondary winding integrated in the first core is wound around outer pillars of the first core and the first tertiary winding is wound around a central pillar of the first core, and wherein the second secondary winding integrated in the second core is wound around outer pillars of the second core and the second tertiary winding is wound around a central pillar of the second core.

With reference to at least FIGS. 8A-8B, it should be appreciated that one example second embodiment of a converter module (56b) includes a converter module (56b), including: a first converter (58), including: first primary side circuitry (62) having first primary side switches; first secondary side circuitry (70) having a first current doubler and first secondary side switches; a first transformer (68a) arranged with first and second primary windings (102a, 102b), the first transformer coupled to the first current doubler, wherein the first current doubler includes a first pair of inductors (80a, 80b) having a first secondary winding (110) and a second secondary winding (112), the first secondary winding (110) coupled to the first primary winding (102a) of the first transformer and the second secondary winding (112) coupled to the second primary winding (102b) of the first transformer; a second converter (60), including: second primary side circuitry having second primary side switches; second secondary side circuitry having a second current doubler and second secondary side switches; a second transformer arranged with third and fourth primary windings, the second transformer coupled to the second current doubler, wherein the second current doubler includes a second pair of inductors (80c, 80d) having a third secondary winding and a fourth secondary winding, the third secondary winding coupled to the third primary winding of the second transformer and the fourth secondary winding coupled to the fourth primary winding of the second transformer; and a first tertiary winding loop (78b-2) and a second tertiary winding loop (78b-1), wherein: the first tertiary winding loop includes first plural tertiary windings coupling the first secondary winding to the fourth secondary winding, the first tertiary winding loop connecting the first plural tertiary windings and a first inserted inductor (108) in a series arrangement; the second tertiary winding loop includes second plural tertiary windings coupling the second secondary winding to the third secondary winding, the second tertiary winding loop connecting the second plural tertiary windings and a second inserted inductor (82) in a series arrangement, wherein the first inserted inductor is coupled to the second inserted inductor.

The example second embodiment may include any one or a combination of the following features.

The converter module of the example second embodiment, wherein the first primary winding, the first secondary winding, and one of the first plural tertiary windings are wound around a central pillar of a first core, wherein the second primary winding, the second secondary winding, and the other of the first plural tertiary windings are wound around a central pillar of a second core, wherein the third primary winding, the third secondary winding, and one of the second plural tertiary windings are wound around a central pillar of a third core, and wherein the fourth primary winding, the fourth secondary winding, and the other of the second plural tertiary windings are wound around a central pillar of a fourth core.

For the converter module of the example second embodiment, the first and second primary side circuitry comprise a full bridge circuit.

For the converter module of the example second embodiment, the first and second primary side circuitry comprise a half bridge circuit.

For the converter module of the example second embodiment, the first pair of inductors is associated with a first channel and the second pair of inductors is associated with a second channel.

With reference to at least FIGS. 9A-9C it should be appreciated that one example third embodiment of a converter module (56c) includes a first converter (58), including: first primary side circuitry (62) having first primary side switches; first secondary side circuitry (70) having a first current doubler and first secondary side switches; a first transformer (68b) arranged with first and second primary windings (102a, 102b), the first transformer coupled to the first current doubler, wherein the first current doubler includes a first pair of inductors (80a, 80b), the first pair of inductors including a first secondary winding (110) coupled to the first primary winding and a second secondary winding (112) coupled to the second primary winding; a second converter (60), including: second primary side circuitry having second primary side switches; second secondary side circuitry having a second current doubler and second secondary side switches; a second transformer arranged with third and fourth primary windings, the second transformer coupled to a second current doubler, wherein the second current doubler includes a second pair of inductors (80c, 80d), the second pair of inductors including a third secondary winding coupled to the third primary winding and a fourth secondary winding coupled to the fourth primary winding; and a tertiary winding loop including plural tertiary windings, wherein one of the plural tertiary windings (128) is coupled to the first and second secondary windings, wherein another of the plural tertiary windings is coupled to the third and fourth secondary windings, and wherein: for the first current doubler, the one of the plural tertiary windings is wound around a central pillar (136) of a first core (132), and the first and second secondary windings and the first and second primary windings are wound around outer pillars (134) of the first core; and for the second current doubler, the another of the plural tertiary windings is wound around a central pillar of a second core, and the third and fourth secondary windings and the third and fourth primary windings are wound around outer pillars of the second core.

The example third embodiment may include any one or a combination of the following features.

For the converter module of the example third embodiment, the tertiary winding loop connects the plural tertiary windings and an inserted inductor (82) in a series arrangement.

For the converter module of the example third embodiment, for the first current doubler, the tertiary winding loop further includes a first inserted inductor (142) connected in series with the one of the plural tertiary windings; and for the second current doubler, the tertiary winding loop further includes a second inserted inductor connected in series with the another of the plural tertiary windings.

Having described certain embodiments of a converter module and associated control methods, and with reference to at least FIGS. 10A-10B and 16, it should be appreciated that one example first embodiment of a method (224) of controlling a converter module (56a) is disclosed, the converter module including multiple converters (58, 60) with outputs respectively arranged in a current doubler configuration, wherein the multiple converters include plural switches and multiple coupled transformers (67, 67a) that include primary, secondary, and tertiary windings. The method of the first embodiment includes receiving an output voltage signal from the multiple converters (226); receiving a tertiary loop current from at least one tertiary loop connecting the tertiary windings (228); and controlling the plural switches based on the output voltage signal and the tertiary loop current (230).

The example first method embodiment may include any one or a combination of the following features.

For the example first method embodiment, the controlling includes converting an input voltage to the converter module to an output voltage that is at a different voltage level than the input voltage by modulating the plural switches.

For the example first method embodiment, controlling the plural switches includes implementing valley current mode control, where controlling the plural switches includes: providing a trigger (154) based on the tertiary loop current and the output voltage signal; selectively enabling one of plural logic circuits (172) of a sequencer (158) based on the trigger; and triggering an on-time duration for a switching pulse, the switching pulse generated by one of the plural switches, from an on-time generation circuit (160) based on the enabled one of the plural logic circuits.

For the example first method embodiment, controlling the plural switches includes, for steady state operation, providing a variable phase shift among the plural switches, wherein at any given instant, only one of the plural switches is on.

For the example first method embodiment, controlling the plural switches includes, for transient operation, providing a phase overlap sequence of switching pulses from respective switches of the plural switches from different converters among the multiple converters, wherein providing the phase overlap includes overlapping a gating sequence of the respective switches of the plural switches from the different converters.

For the example first method embodiment, for transient operation, providing the trigger is further based on a feed forward voltage (vohpf) that is based on high-pass or band-pass filtering the output voltage signal.

For the example first method embodiment, for transient operation, providing the trigger is further based on a feed forward voltage (vohpf) that is based on high-pass or band pass filtering the output voltage signal, wherein for transient operation, controlling the plural switches includes: providing a phase overlap sequence of switching pulses from a respective switch of the plural switches from different converters, wherein providing the phase overlap includes overlapping a gating sequence of the respective switch of the plural switches from different converters.

For the example first method embodiment, the on-time duration is constant or variable.

For the example first method embodiment, controlling the plural switches includes balancing current flow between the multiple converters by: measuring DC currents from DC positive terminals of the multiple converters to obtain measured DC currents; and adjusting the on-time duration of one or more of the plural switches based on the measured DC currents.

With reference to at least FIGS. 10A-10B and 16, it should be appreciated that one example fourth embodiment of a converter module (56d) includes multiple converters (58, 60) with outputs respectively arranged in a current doubler configuration, wherein the multiple converters include plural switches (S1, S2, S3, S4) and multiple coupled transformers including primary, secondary, and tertiary windings; and a control module (146) configured to: receive an output voltage signal from the multiple converters (226); receive a tertiary loop current from at least one tertiary loop connecting the tertiary windings (228); and control the plural switches based on the output voltage signal and the tertiary loop current (230).

The example fourth embodiment may include any one or a combination of the following features.

For the example fourth embodiment, the control module is configured to convert an input voltage to an output voltage that is at a different voltage level than the input voltage by modulating the plural switches.

For the example fourth embodiment, the control module is configured to implement valley current mode control, where the control module includes a sequencer circuit (158) having plural logic circuits (172), and an on-time generation circuit (160), wherein the control module is configured to: provide a trigger based on the tertiary loop current and the output voltage signal; selectively enable one of the plural logic circuits of the sequencer circuit based on the trigger; and trigger an on-time duration for a switching pulse, the switching pulse generated by one of the plural switches, from the on-time generation circuit based on the enabled one of the plural logic circuits.

For the example fourth embodiment, for steady state operation, the control module is configured to provide a variable phase shift among the plural switches, wherein at any given instant, only one of the plural switches is on.

For the example fourth embodiment, the control module includes a phase overlap controller (156), wherein for transient operation, the control module is configured to provide a phase overlap sequence of switching pulses from respective switches of the plural switches from different converters among the multiple converters, wherein the phase overlap includes an overlapping gating sequence of the respective switches of the plural switches from the different converters.

For the example fourth embodiment, the control module includes a transient feed forward circuit (162) including a high-pass or band-pass filter, wherein for transient operation, the control module is configured to provide the trigger based on a feed forward voltage (vohpf) that is based on high-pass or band pass filtering the output voltage signal.

For the example fourth embodiment, the control module includes a phase overlap controller (156), and a transient feed forward circuit (162) including a high-pass or band pass filter, wherein for transient operation, the control module is configured to: provide the trigger based on a feed forward voltage (vohpf) that is based on high-pass or band pass filtering the output voltage signal; and provide a phase overlap sequence of switching pulses from a respective switch of the plural switches from different converters among the plural converters, wherein the phase overlap includes an overlapping gating sequence of the respective switch of the plural switches from different converters.

For the example fourth embodiment, the control module includes an adaptive on-time control circuit (164), wherein the control module is configured to balance current flow between the multiple converters by: measuring DC currents from DC positive terminals of the multiple converters to obtain measured DC currents; and adjusting the on-time duration of one or more of the plural switches based on the measured DC currents.

For the example fourth embodiment, the control module includes: a transient feed forward circuit (162) including a high-pass or band pass filter, wherein for transient operation, the control module is configured to provide the trigger based on a feed forward voltage (vohpf) that is based on high-pass or band pass filtering the output voltage signal and provide a phase overlap sequence of switching pulses from a respective switch of the plural switches from different converters among the plural converters, wherein the phase overlap includes an overlapping gating sequence of the respective switch of the plural switches from different converters; and an adaptive on-time control circuit (164), wherein the control module is configured to balance current flow between the multiple converters by: measuring DC currents from DC positive terminals of the multiple converters to obtain measured DC currents; and adjusting the on-time duration of one or more of the plural switches based on the measured DC currents.

With reference to at least FIGS. 10A-10B and 16, it should be appreciated that one example first embodiment of a control module (146) for a converter module (56d) is disclosed. The converter module includes multiple converters (58, 60) with outputs respectively arranged in a current doubler configuration, wherein the multiple converters include plural switches (S1, S2, S3, S4) and multiple coupled transformers including primary, secondary, and tertiary windings. The control module is configured to: receive an output voltage signal from the multiple converters (226); receive a tertiary loop current from at least one tertiary loop connecting the tertiary windings (228); and control the plural switches based on the output voltage signal and the tertiary loop current (230).

For the example first embodiment of the control module, the control module is configured to implement valley current mode control, where the control module includes a sequencer circuit (158) having plural logic circuits (172), and an on-time generation circuit (160), wherein the control module is configured to: provide a trigger based on the tertiary loop current and the output voltage signal; selectively enable one of the plural logic circuits of the sequencer circuit based on the trigger; and trigger an on-time duration for a switching pulse, the switching pulse generated by one of the plural switches, from the on-time generation circuit based on the enabled one of the plural logic circuits; wherein the control module includes one or a combination of the following: a phase overlap controller (156), wherein for transient operation, the control module is configured to provide a phase overlap sequence of switching pulses from respective switches of the plural switches from different converters among the multiple converters, wherein the phase overlap includes an overlapping a gating sequence of the respective switches of the plural switches from the different converters; a transient feed forward circuit (162) including a high-pass or and -pass filter, wherein for transient operation, the control module is configured to provide the trigger based on a feed forward voltage (vohpf) that is based on high-pass or band-pass filtering the output voltage signal; and an adaptive on-time control circuit (164), wherein the control module is configured to balance current flow between the multiple converters by: measuring DC currents from DC positive terminals of the multiple converters to obtain measured DC currents; and adjusting the on-time duration of one or more of the plural switches based on the measured DC currents.

It is noted that the first embodiment of the control method and the first embodiment of the control module may be used with any of the converter module embodiments described herein.

While the invention has been illustrated and described in detail in the drawings and foregoing description, such illustration and description are to be considered illustrative or exemplary and not restrictive. Accordingly, it should be understood that where features mentioned in the appended claims (or above paragraphs of the first through fourth embodiments and example first embodiments for the control method and control module) are followed by reference signs, such signs are included solely for the purpose of enhancing the intelligibility of the claims and are in no way limiting on the scope of the claims or specification. The invention is not limited to the disclosed embodiments. Other variations to the disclosed embodiments can be understood and effected by those skilled in the art in practicing the claimed invention, from a study of the drawings, the disclosure, and the appended claims. Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality.

At least the following is claimed:

1. A converter module, comprising:
a first converter, comprising:
first primary side circuitry having first primary side switches;
first secondary side circuitry having a first current doubler and first secondary side switches, the first current doubler comprising a first pair of inductors having first secondary windings integrated in a first core; and
a first transformer coupled to the first current doubler;
a second converter, comprising:
a second primary side circuitry having second primary side switches;
second secondary side circuitry having a second current doubler and second secondary side switches, the second current doubler comprising a second pair of inductors having second secondary windings integrated in a second core; and
a second transformer coupled to the second current doubler; and
a tertiary winding loop comprising an inserted inductor and first and second tertiary windings coupling the first pair of inductors with the second pair of inductors respectively.

2. The converter module of claim 1, wherein the first and second primary side circuitry comprise a full bridge circuit.

3. The converter module of claim 1, wherein the first and second primary side circuitry comprise a half bridge circuit.

4. The converter module of claim 1, wherein the first pair of inductors is associated with a first channel and the second pair of inductors is associated with a second channel.

5. The converter module of claim 1, wherein the tertiary winding loop connects the first and second tertiary windings and the inserted inductor in a series arrangement.

6. The converter module of claim 5, wherein the first secondary winding integrated in the first core is wound around outer pillars of the first core and the first tertiary winding is wound around a central pillar of the first core, and
wherein the second secondary winding integrated in the second core is wound around outer pillars of the second core and the second tertiary winding is wound around a central pillar of the second core.

7. A converter module, comprising:
a first converter, comprising:
first primary side circuitry having first primary side switches;
first secondary side circuitry having a first current doubler and first secondary side switches;
a first transformer arranged with first and second primary windings, the first transformer coupled to the first current doubler,
wherein the first current doubler comprises a first pair of inductors having a first secondary winding and a second secondary winding, the first secondary winding coupled to the first primary winding of the first transformer and the second secondary winding coupled to the second primary winding of the first transformer;
a second converter, comprising:
second primary side circuitry having second primary side switches;
second secondary side circuitry having a second current doubler and second secondary side switches;
a second transformer arranged with third and fourth primary windings, the second transformer coupled to the second current doubler,
wherein the second current doubler comprises a second pair of inductors having a third secondary winding and a fourth secondary winding, the third secondary winding coupled to the third primary winding of the second transformer and the fourth secondary winding coupled to the fourth primary winding of the second transformer; and
a first tertiary winding loop and a second tertiary winding loop, wherein:
the first tertiary winding loop comprises first plural tertiary windings coupling the first secondary winding to the fourth secondary winding, the first tertiary winding loop connecting the first plural tertiary windings and a first inserted inductor in a series arrangement;
the second tertiary winding loop comprises second plural tertiary windings coupling the second secondary winding to the third secondary winding, the second tertiary winding loop connecting the second plural tertiary windings and a second inserted inductor in a series arrangement,
wherein the first inserted inductor is coupled to the second inserted inductor.

8. The converter module of claim 7, wherein the first primary winding, the first secondary winding, and one of the first plural tertiary windings are wound around a central pillar of a first core,
wherein the second primary winding, the second secondary winding, and the other of the first plural tertiary windings are wound around a central pillar of a second core,
wherein the third primary winding, the third secondary winding, and one of the second plural tertiary windings are wound around a central pillar of a third core, and
wherein the fourth primary winding, the fourth secondary winding, and the other of the second plural tertiary windings are wound around a central pillar of a fourth core.

9. The converter module of claim 7, wherein the first and second primary side circuitry comprise a full bridge circuit.

10. The converter of claim 7, wherein the first and second primary side circuitry comprise a half bridge circuit.

11. The converter module of claim 7, wherein the first pair of inductors is associated with a first channel and the second pair of inductors is associated with a second channel.

12. A converter module, comprising:
a first converter, comprising:
first primary side circuitry having first primary side switches;
first secondary side circuitry having a first current doubler and first secondary side switches;
a first transformer arranged with first and second primary windings, the first transformer coupled to the first current doubler,
wherein the first current doubler comprises a first pair of inductors, the first pair of inductors comprising a first secondary winding coupled to the first primary winding and a second secondary winding coupled to the second primary winding;
a second converter, comprising:
second primary side circuitry having second primary side switches;
second secondary side circuitry having a second current doubler and second secondary side switches;
a second transformer arranged with third and fourth primary windings, the second transformer coupled to a second current doubler,
wherein the second current doubler comprises a second pair of inductors, the second pair of inductors comprising a third secondary winding coupled to the third primary winding and a fourth secondary winding coupled to the fourth primary winding; and
a tertiary winding loop comprising plural tertiary windings, wherein one of the plural tertiary windings is coupled to the first and second secondary windings, wherein another of the plural tertiary windings is coupled to the third and fourth secondary windings, and wherein:
for the first current doubler, the one of the plural tertiary windings is wound around a central pillar of a first core, and the first and second secondary windings and the first and second primary windings are wound around outer pillars of the first core; and
for the second current doubler, the another of the plural tertiary windings is wound around a central pillar of a second core, and the third and fourth secondary windings and the third and fourth primary windings are wound around outer pillars of the second core.

13. The converter module of claim 12, wherein the tertiary winding loop connects the plural tertiary windings and an inserted inductor in a series arrangement.

14. The converter module of claim 12, wherein:
for the first current doubler, the tertiary winding loop further comprises a first inserted inductor connected in series with the one of the plural tertiary windings; and
for the second current doubler, the tertiary winding loop further comprises a second inserted inductor connected in series with the another of the plural tertiary windings.
